(19) United States
(12) Patent Application Publication
(10) Pub. No.: US 2026/0356045 A1
(43) Pub. Date: Nov. 12, 2026

(54) ADAPTIVE VALVE-BASED FLOW CONTROL IN 3D PRINTING

(71) Applicant: Elastium, Inc., Los Angeles, CA (US)

(72) Inventor: Robert Karklinsh, Los Angeles, CA (US)

(21) Appl. No.: 19/675,337

(22) Filed: May 12, 2026

Related U.S. Application Data
(60) Provisional application No. 63/803,958, filed on May 12, 2025.

(51) Int. Cl. B29C 64/393; B25J 11/00; B29C 64/118; B29C 64/209; B29C 64/321; B29C 64/35; B33Y 10/00; B33Y 30/00; B33Y 40/00; B33Y 50/02

(52) U.S. Cl. CPC B29C 64/393; B29C 64/118; B29C 64/209; B29C 64/321; B29C 64/35; B33Y 10/00; B33Y 30/00; B33Y 40/00; B33Y 50/02; B25J 11/0075

(57) ABSTRACT

Disclosed are manufacturing systems and methods. A manufacturing system includes: a printhead including a nozzle, a pressure-generating mechanism configured to advance a polymer material through a polymer processing space toward the nozzle, and an actively controlled valve including a valve element and configured to regulate discharge of the polymer material from the nozzle; a motion system configured to move the printhead relative to a build surface along a toolpath including a plurality of deposition segments separated by one or more non-printing moves; a purging station configured to receive or remove excess polymer material from the printhead; and a control system operably coupled to the printhead, the actively controlled valve, the pressure-generating mechanism, and the motion system.

### CROSS-REFERENCE TO RELATED APPLICATION(S)

This patent document claims priority to and the benefit of U.S. Provisional Application No. 63/803,958, filed on May 12, 2025, the content of which is hereby incorporated by reference.

### TECHNICAL FIELD

The present disclosure generally relates to extrusion-based manufacturing and hybrid manufacturing. In particular, it concerns an adaptive method for controlling material flow using an actively operated control valve in coordination with motion control, material processing, and path planning.

### BACKGROUND

Extrusion-based additive manufacturing—including fused filament fabrication (FFF) and fused granule fabrication (FGF)—fabricates three-dimensional objects by depositing a flowable material, such as a polymer, through a nozzle of a printhead onto a build surface along a toolpath, the toolpath comprising deposition segments separated by non-printing moves. Material flow during deposition is governed by a pressure-generating mechanism within the printhead, and may be further regulated by one or more valves operable to vary the discharge of material from the nozzle. Various aspects of extrusion-based additive manufacturing systems are described in publicly available technical literature and patent publications.

### BRIEF DESCRIPTION OF THE DRAWINGS

FIG. 1 shows a flowchart illustrating an exemplary high-level method for adaptive valve management during an additive manufacturing process, according to some embodiments of the present disclosure.

FIG. 2 is a flowchart illustrating an embodiment of a detailed method for performing adaptive valve management in conjunction with purging operations during additive manufacturing, according to some embodiments of the present disclosure.

FIGS. 3A-3C illustrate an example of progressive valve closure along a deposition segment, according to some embodiments of the present disclosure. FIG. 3A shows a printhead positioned over a segment before the start of closure, with a valve in an open state. FIG. 3B shows the printhead as the valve transitions to a partially closed state near the end of the segment. FIG. 3C shows the printhead after completing the segment, with the valve closed in preparation for a non-printing move.

FIGS. 4A-4B illustrate an exemplary process of valve opening at the start of a new segment, according to some embodiments of the present disclosure. FIG. 4A shows the printhead positioned at the beginning of the segment with the valve in a closed state. FIG. 4B shows the printhead during extrusion, with the valve in an open state.

FIGS. 5A-5C depict an exemplary process for handling a scenario in which the segment length is insufficient for full valve closure prior to a non-printing move, according to some embodiments of the present disclosure. FIG. 5A shows the printhead over a short segment before the non-printing move with the valve in an open state, the segment length being insufficient to permit complete valve closure. FIG. 5B shows the printhead with the valve partially closed near the end of the segment, optionally executing a rapid valve retraction maneuver immediately before the non-printing move. FIG. 5C shows the system immediately after executing the non-printing move with the valve in a partially open state.

FIGS. 6A-6E show an isometric sectional view of an exemplary 3D printer, with portions removed to illustrate internal features, performing an exemplary operational sequence comprising an escape move followed by a purging procedure, according to some embodiments of the present disclosure.

FIGS. 7A-7E show exemplary profiles of extrusion feed rate, deposition speed, and valve position during deposition of a segment in a 3D printing process, according to some embodiments of the present disclosure.

### DETAILED DESCRIPTION

In existing extrusion-based additive manufacturing systems, such as fused filament fabrication (FFF) and fused granule fabrication (FGF), stoppage of material flow is commonly implemented via material retraction techniques. However, such retraction-based approaches frequently fail to eliminate undesirable phenomena such as oozing, stringing, or extrusion inconsistencies during start-and-stop transitions. These issues may be pronounced in FGF systems, where material retractions may destabilize the extrusion process, especially when printing short path segments, processing thermally sensitive or foaming polymer formulations, or operating at elevated deposition rates.

Certain systems incorporate mechanically operated valves to block or permit flow at the nozzle level. For example, some existing systems include developed printheads with integrated needle valves that close the nozzle at the end of extrusion segments. For example, in some systems, the needle valve operates vertically, providing a physical shutoff alternative to filament retraction. As another example, in a valve-driven extrusion system, the extruder screw itself acts as the valve, stopping material flow. However, these systems lack the precision and adaptability required for fine-grained flow control under dynamic printing conditions.

Some existing systems involve algorithms that coordinate valve closure while the nozzle is in motion (‘retract-while-moving’) to reduce material accumulation caused by pressure lag. Formula-based compensations for pressure smoothing and material redistribution may bring about improvements in stringing control. However, such solution assumes simplified toolpath transitions and lacks adaptability for short path segments or material-specific behavior, e.g., in applications involving thermally sensitive or foamed polymers.

Moreover, existing systems and methods employing actively controlled valves for extrusion flow regulation do not address several practical constraints, including: (i) the maximum permissible frequency of valve actuations; (ii) minimum volumetric thresholds required to achieve valve closure during motion without over-deposition; (iii) fallback handling where standard valve operation is not feasible; and (iv) integrated purging routines needed to maintain consistent print quality.

Notably, existing systems inadequately address a limitation: the inability to consistently print short segments, e.g., in fused granulate fabrication (FGF) processes. Although needle valve mechanisms and other flow-interruption strategies have been disclosed, these approaches often fail to fully address the issue. In many cases, the volume of material unintentionally discharged—due to residual pressure and valve actuation displacement—exceeds the intended volume of the short segment, resulting in significant inaccuracies.

Another limitation, e.g., relevant to FGF printing, is the occurrence of extrusion process instabilities caused by flow stoppages and non-printing travel moves. These disruptions may further be exacerbated in systems utilizing in-situ foaming, where maintaining consistent flow and pressure is essential. Any interruption can lead to pressure fluctuations, inconsistent foaming behavior, and degradation of print quality, making this a primary challenge in achieving reliable and repeatable results.

Thus, there remains a need for improved additive manufacturing systems and methods.

The present disclosure provides methods and systems for adaptive flow control in extrusion-based additive manufacturing systems utilizing an actively controlled valve, particularly in Fused Granule Fabrication (FGF) and Fused Filament Fabrication (FFF) systems. The disclosed techniques enable system-level control over material flow, including full and partial valve closure, flow rate modulation, and fallback purging procedures, statically or dynamically adapted to geometric features, extrusion parameters, material properties, and system constraints, including valve actuation limits. In certain embodiments, the systems may incorporate vacuum-assisted purging stations and insulated chamber access mechanisms. The disclosed methods support high-precision, extrusion-based three-dimensional printing across a variety of system configurations and process modalities.

The present disclosure includes subject matter that builds upon and expands the technologies disclosed in U.S. Patent Application Publications No. US20240351277A1 and US20240253309A1, the entire contents of which are hereby incorporated by reference. Certain descriptions, system elements, and method steps in the present application are identical or substantially similar to those disclosed in US20240351277A1 and US20240253309A1, and are optionally enhanced or modified to enable new functionalities and use cases.

Without limitation, the disclosed systems and methods are applicable to extrusion-based additive manufacturing processes, including but not limited to fused filament fabrication (FFF) and fused granule fabrication (FGF), and are compatible with a wide range of platform types. Applicable platforms may include, without limitation, cartesian systems, delta systems, infinite-build systems (e.g., belt-type 3D printers), robotic arm-mounted systems, and other three-dimensional printing platforms.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no aspects included in the documents are incorporated by reference herein, and any definitions provided in the documents are not incorporated by reference herein unless expressly included herein.

References to items in the singular should be understood to include items in the plural, and vice versa, unless explicitly stated otherwise or clear from the text. The use of the term “or” in the aspects is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and aspect(s), the words “comprising” (and any form of comprising, such as “comprise” and “comprises”), “having” (and any form of having, such as “have” and “has”), “including” (and any form of including, such as “includes” and “include”), “containing” (and any form of containing, such as “contains” and “contain”) or “constituting” (and any form of constituting, such as “constitutes” and “constitute”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), property(s), method/process steps or limitation(s)) only.

The term “and combinations thereof” as used herein refers to all permutations and combinations of the listed items preceding the term. For example, “A, B, C, and combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

The words “about,” “approximately” or the like, when accompanying a numerical value, are to be construed as indicating a deviation as would be appreciated by one of ordinary skill in the art to operate satisfactorily for an intended purpose. In general, but subject to the preceding discussion, a numerical value herein that is modified by a word of approximation such as “about” may vary from the stated value by at least ±1, 2, 3, 4, 5, 6, 7, 10, 12, 15, 20 or 25%. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose or the like.

All of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended aspects.

For purposes of clarity, references to “X”, “Y,” and “Z” axes throughout this disclosure are made with respect to a nominal Cartesian coordinate system, in which the Z-axis is typically understood to be vertical and the X and Y axes define a horizontal plane. These designations are made solely to aid in the understanding of spatial relationships and are not intended to be limiting. A person skilled in the art will recognize that the described systems and methods may be implemented in any orientation, including permutations or reassignment of the axes, or in coordinate systems that are non-Cartesian, non-orthogonal, or otherwise arbitrarily defined, without departing from the scope of the invention.

As used herein, directional terms such as “above,” “below,” “top,” “bottom,” and similar expressions are provided for illustrative purposes and are made with reference to either the Z-axis of a nominal Cartesian coordinate system or the direction of layer-wise material deposition in a three-dimensional printing process. In conventional configurations, the Z-axis typically aligns with the direction of layer-wise material deposition. However, in certain embodiments—such as those employing non-planar, tilted, or rotational build surfaces, including in multi-axis (e.g., five-axis) additive manufacturing systems—there may be no singular or fixed build direction. In such cases, the foregoing directional terms shall be construed relative to either the Z-axis or the instantaneous direction of layer formation, as appropriate, and are not intended to impose any structural or spatial limitation on the claimed invention.

The term “providing”, such as for “providing a print head”, when recited in the claims, is not intended to require any particular delivery or receipt of the provided item. Rather, the term “providing” is merely used to recite items that will be referred to in subsequent elements of the claim(s), for purposes of clarity and ease of readability. The terms “about” and “substantially” are used herein with respect to measurable values and ranges due to expected variations known to those skilled in the art (e.g., limitations and variabilities in measurements).

As used herein, the terms “system”, “additive manufacturing system,” “3D printer,” and “3D printing system” refer broadly to any apparatus or system configured to fabricate parts, prototypes, components, or support structures at least partially through one or more additive manufacturing processes. The additive manufacturing system may comprise a standalone unit or may function as a sub-system within a larger integrated 3D printer farm or production line. The system may be implemented within an enclosed environment (e.g., a thermally or atmospherically controlled enclosure) or in an open configuration. In certain embodiments, the additive manufacturing system may additionally incorporate non-additive manufacturing functionalities, including but not limited to subtractive manufacturing (e.g., milling, cutting), pick-and-place automation, laser-based processing (e.g., ablation, cutting, sintering), or two-dimensional printing technologies. Accordingly, the terms “3D printing” and “additive manufacturing” as used herein shall be construed to encompass hybrid manufacturing approaches that combine additive processes with one or more non-additive techniques, unless expressly stated otherwise.

As used herein, the term “tool” broadly refers to any device operable within the 3D printing system, including, without limitation, material extrusion printheads, material deposition devices, forming or shaping elements, rollers, cutters, localized heating devices (e.g., resistive or radiative heaters, lasers), localized cooling elements, fiber reinforcement applicators (e.g., carbon fiber deposition modules), sensing or monitoring units (e.g., optical imaging systems, cameras), and metrology instruments (e.g., laser rangefinders, contact or non-contact probes) configured to detect part geometry, dimensional properties, or surface features during or after fabrication. As used herein, the term “active tool” refers to a tool that is currently operatively engaged with the build process, i.e., a tool that is actively performing its intended function (e.g., depositing material, cutting, heating, or sensing) at a given time during operation.

A 3D printer of the present disclosure includes a build surface on which a material is to be deposited. For example, the build surface may be a substantially flat surface of a build plate of the 3D printer that is moved in Z direction. As another example, the build surface may be a curved surface, such as a surface of a shoe last placed inside the 3D printer. As another example, the build surface may be defined by the surface of an object incorporated into the printed part using a pick-and-place tool.

The 3D printer may further include a positioning system configured to position a tool relative to the build surface. A variety of positioning systems are known in the art and suitable for use as the positioning system. For example, the positioning system may include a Cartesian coordinate positioning system or X-Y-Z positioning system employing a number of linear controls to move independently in the X-axis, the Y-axis, and the Z-axis. Alternatively, or in addition, Delta positioning systems may be usefully employed. Alternatively, yet, or in addition, robotic manipulators may be usefully employed. More generally, any positioning system suitable for controlled positioning of the tool relative to the build surface may be usefully employed. For example, the tool may be operably coupled to the positioning system such that the positioning system positions the tool. The build surface may also, or instead, be operably coupled to the positioning system such that the positioning system positions the build surface. Some other combinations of these techniques may be employed, such as by moving the tool up and down for Z-axis control, and moving the build surface within the X-Y plane to provide X-axis and Y-axis control. In some implementations, the positioning system may translate the build surface along one or more axes, and/or may rotate the build surface. The positioning system may include a number of electric motors to independently control the position of the tool or the build surface along each axis, e.g., an X-axis, a Y-axis, and a Z-axis. More generally, the positioning system may include various combinations of stepper motors, linear motors, servo motors, gears, belts, pulleys, worm gears, threads, and the like. Any such arrangement suitable for controllably positioning the tool or the build surface may be adapted to use with the 3D printing system.

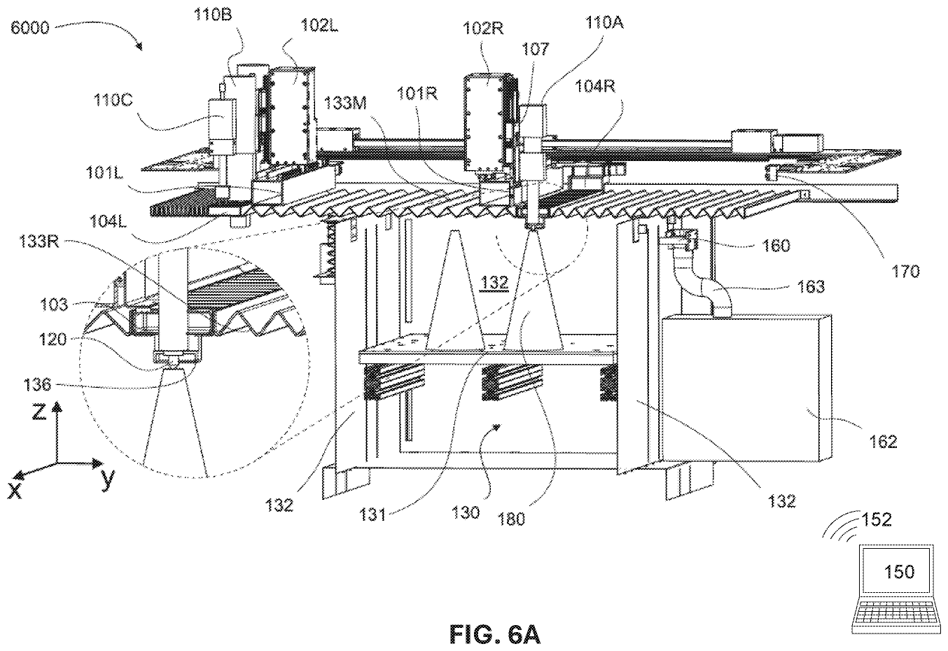

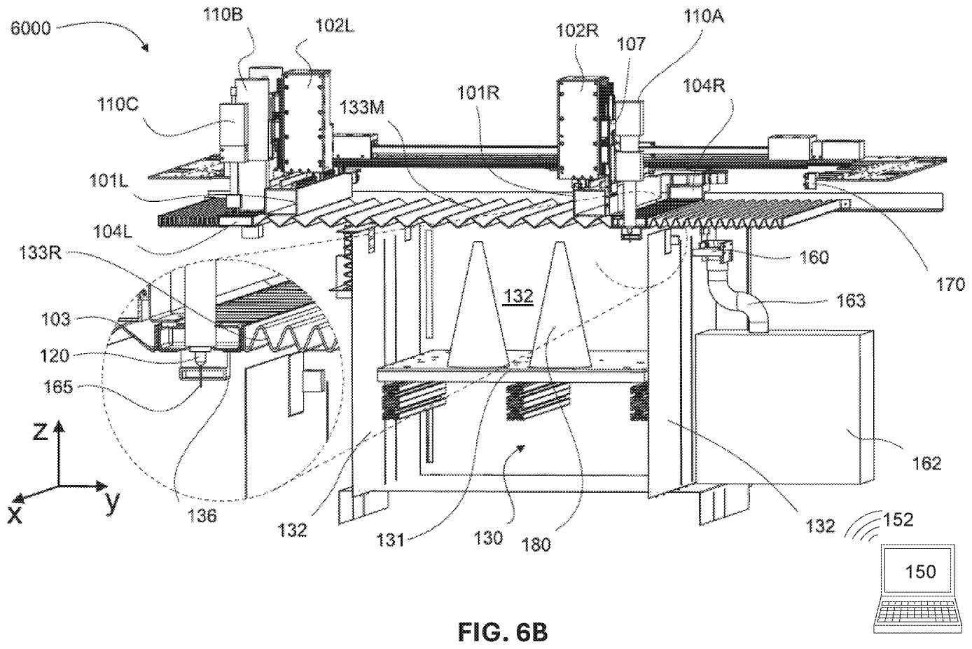

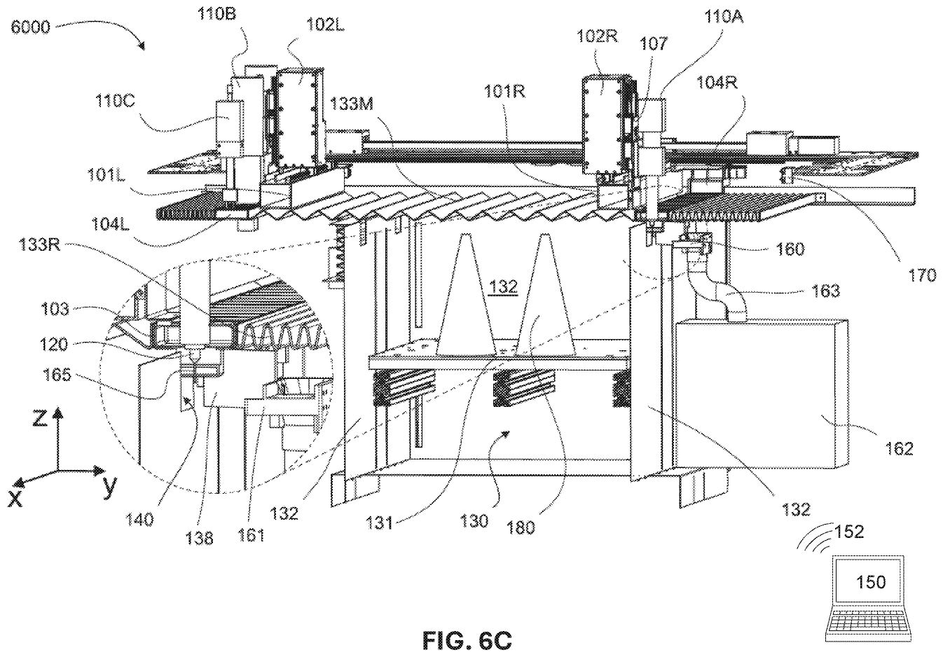

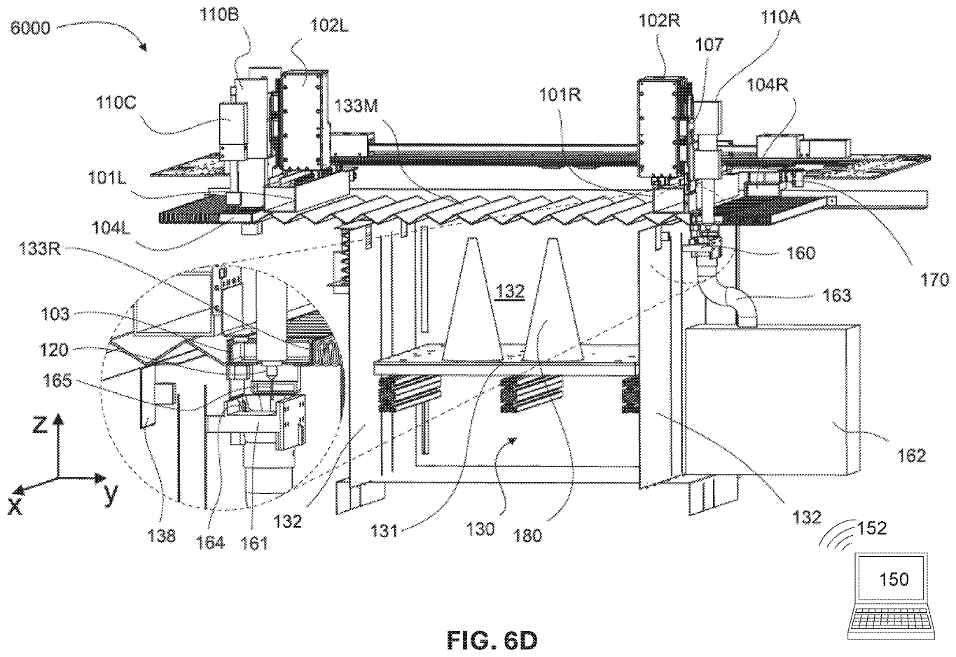

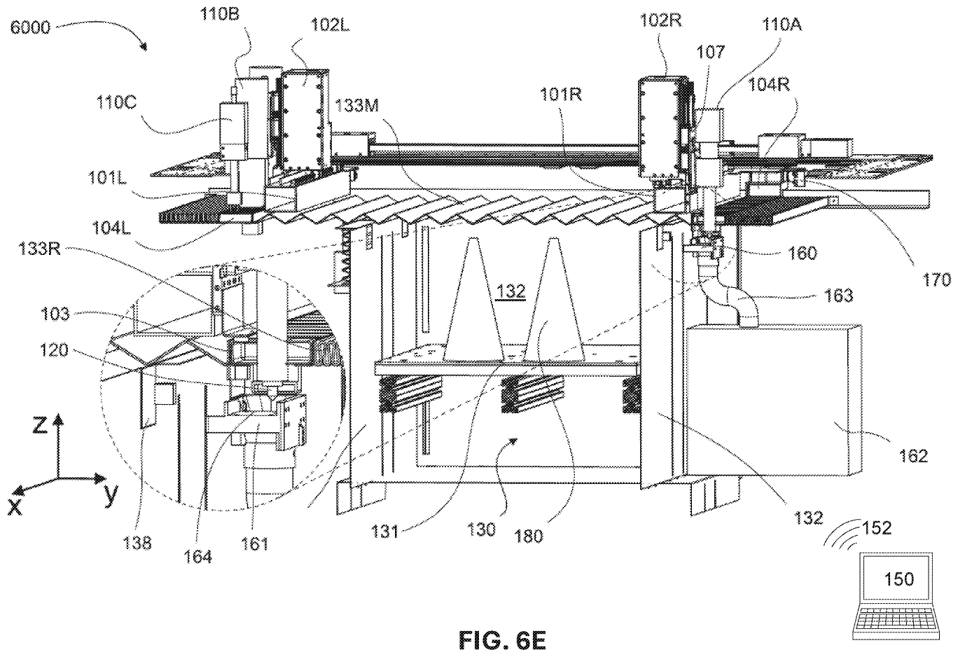

The 3D printer further includes a control system (e.g., 150 in FIG. 6A-6E). The 3D printer may include a communication link (e.g., 152 in FIG. 6A-6E) that links the control system with a tool to establish communication between the control system and the tool. The 3D printer may include a communication link (e.g., 152 in FIG. 6A-6E) that links the control system with the positioning system to establish communication between the control system and the positioning system. The control system may be configured to control the extrusion and the relative motion of the tool relative to the build surface to fabricate the object on the build surface by sequentially depositing a plurality of layers of the deposition material, wherein the deposition of a layer of the deposition material includes extruding the deposition material towards a deposition surface while moving the tool relative to the build surface to deposit the deposition material on the deposition surface. The control system may execute instructions generated based on a three-dimensional model or any other digital representation of the object, the instructions defining the 3D printing process. The instructions may be generated externally and input to the control system. Alternatively, or in addition, the instructions may be generated by the control system itself. For example, instructions may define the movement path of the tool relative to the build surface, further referred as tool path. The tool path may be predefined. Alternatively, or in addition, a portion of the tool path may be generated and/or adjusted dynamically during the 3D printing process. The control system may be a distributed system consisting of a plurality of subsystems. For example, the control system may comprise a cloud-based subsystem, which may be configured to generate high-level instructions based on a three-dimensional model of the object. The control system may further comprise a path planning subsystem connected to the cloud-based system over a wired or wireless interface, the path planning subsystem may interpret the high-level instructions received from the cloud-based system by generating low-level instructions corresponding to the tool path for motors of the positioning system and transfer them to the positioning system over the communication link. The control system may be implemented using one or more controllers, mounted statically or for movement, interconnected over wired or wireless communication links. The machine-control instructions executable by the control system may take any form suitable for controlling the 3D printer, and may comprise, by way of non-limiting example, G-code or other numerical-control language commands, motion-control commands for the positioning system, valve-position commands for the control valve, feed-rate commands or other commands governing operation of the pressure-generating mechanism, and commands governing purging procedures and other auxiliary functions. The machine-control instructions may be generated before fabrication of an object by a slicer, a computer-aided manufacturing (CAM) system, a cloud-based processing system, or any other computing system separate from the additive manufacturing system, or by the control system of the additive manufacturing system itself, or by any combination thereof. In some embodiments, the machine-control instructions, or the instructions executed by a computing system to generate the machine-control instructions, are stored on one or more non-transitory computer-readable media accessible by the control system or by a computing system in communication with the additive manufacturing system. Non-transitory computer-readable media may include, by way of non-limiting example, hard disk drives, solid-state drives, flash memory devices, optical storage media, magnetic storage media, and read-only memory devices.

In some embodiments, the machine-control instructions may be generated by a computer-implemented method performed by a computing system (e.g., 150 in FIGS. 6A-6E) that is positioned separate from or outside the additive manufacturing system (such as a slicer, a CAM system, or a cloud-based processing system), or by a sub-system of the control system itself. Such a computer-implemented method may comprise: receiving toolpath data comprising a plurality of deposition segments and one or more non-printing moves between the deposition segments; for at least one transition from a current deposition segment of the toolpath to a subsequent deposition segment of the toolpath, determining, based on at least one of a length and a volume of the current deposition segment and at least one parameter of the actively controlled valve, whether a terminal portion of the current deposition segment is sufficient to accommodate an expected excess discharge volume associated with transitioning the actively controlled valve toward a closed state; when the terminal portion is sufficient, generating first machine-control instructions configured to cause the additive manufacturing system to perform a first transition protocol as described elsewhere in the present disclosure; when the terminal portion is not sufficient, generating second machine-control instructions configured to cause the additive manufacturing system to perform a second transition protocol as described elsewhere in the present disclosure; and outputting the first or second machine-control instructions for execution by the additive manufacturing system. The instructions so generated may be transmitted to the additive manufacturing system over a wired or wireless communication link, stored locally on the additive manufacturing system, or stored on a removable medium for delivery to the additive manufacturing system.

As used throughout this disclosure, human-like terminology such as “the system decides,” “the system deems,” or “determines whether,” is employed for linguistic clarity and ease of description. Such phrasing does not imply that the system possesses artificial intelligence, cognitive abilities, or autonomous decision-making capabilities. Rather, these expressions refer to logical operations or instructions executed by the control system, which may involve minimal or no real-time decision making. In some instances, such operations may be entirely deterministic or governed by static code with pre-defined parameters.

During the three-dimensional printing process, if the deposition material is deposited on the build surface (for example, the currently deposited layer is the first from the build surface), the term “deposition surface” refers to the build surface. Otherwise, the term “deposition surface” refers to a surface of a previously deposited deposition material. For example, during the deposition of a layer of a deposition material, a deposition surface may be formed by a surface of a previously deposited layer of the deposition material. As another example, a first tool may deposit a first deposition material onto a deposition surface formed by a second deposition material earlier deposited by a second tool.

The 3D printer may comprise an insulated chamber (in this document also referred to as build chamber) within which an object is formed. As used herein, the term “insulated chamber” generally refers to a volume bounded at least in part by one or more insulating structures, which may function to reduce heat loss and retain thermal energy within the chamber volume. In certain embodiments, the insulated chamber may additionally or alternatively be configured for purposes unrelated to thermal regulation. For example, in embodiments incorporating subtractive manufacturing tools (e.g., milling or cutting implements), the insulated chamber may serve to isolate the motion system and associated components from particulate matter or debris generated during subtractive operations, thereby maintaining system cleanliness and operational integrity. Accordingly, references to an “insulated chamber” are not limited to heated enclosures unless explicitly stated, and may encompass a variety of functional configurations. In some implementations, the 3D printer may incorporate just a portion of the insulated chamber. For instance, the 3D printer may include a movable tool tray or gantry-mounted subassembly carrying a dust collection shroud or debris containment feature (e.g., a dust shoe) configured to interface with subtractive tooling during operation.

In certain embodiments, the additive manufacturing system may comprise a subtractive manufacturing tool, distinct from the printhead and operably coupled to the motion system or to a separate motion system of the additive manufacturing system. The subtractive manufacturing tool may comprise, by way of non-limiting example, a milling spindle, a cutting tool, a routing tool, an abrasive finishing tool, or a laser cutting or ablation tool, and may be configured to perform a subtractive operation on polymer material previously deposited by the printhead, including operations such as milling, trimming, surface finishing, cutting, or ablation, in any of the X, Y, or Z directions or any combination thereof. In such embodiments, the insulated chamber described above may further serve to contain debris generated by the subtractive operation.

A 3D printer in accordance with the present disclosure comprises at least one extruder (also referred to herein as the “printhead”) configured to extrude material through an outlet. The printhead includes at least one pressure-generating mechanism. Exemplary pressure-generating mechanisms may be found in the US20240351277A1, which is hereby incorporated by reference. For example, the pressure-generating mechanism may include a positive displacement pump, a dynamic pump, a drag flow pump, a Weissenberg effect pump, a pressurized vessel, or the like, or a combination thereof.

The printhead may further comprise a control valve (also referred to herein simply as the “valve”), such as a needle valve, shutter valve, slide valve, or another suitable flow-regulating mechanism. In some embodiments, the control valve includes a movable component, such as a needle, configured to move relative to a corresponding seat. Alternative movable components may include, without limitation, a plunger, ball, vane, or plug. The movable part may be configured to be positioned relative to the seat such that the size of the flow passage between the movable part and the seat is varied by the positioning of the movable part.

In certain embodiments, the control valve may be actuated by an electric motor operably connected to the movable component and configured to precisely control the position of the movable component relative to the seat. In other embodiments, suitable actuators for the valve may include, without limitation, piezoelectric actuators, solenoids, pneumatic actuators, hydraulic actuators, and combinations thereof. The control valve may be operably connected to the control system of the 3D printer to enable coordinated actuation in conjunction with other subsystems.

Exemplary definitions for fully open and fully closed states of a control valve are presented in U.S. Patent Application Publication No. US20240351277A1, which is hereby incorporated by reference. A state of a control valve refers to a configuration of the control value distinguished by a form of a flow passage of the control value through which a material (e.g., a polymer material) flows. “Opening” a control valve refers to transitioning the valve from a state of higher backpressure (“less open”) toward a state of lower backpressure (“more open”), whereas “closing” refers to transitioning the valve from a state of lower backpressure (“less closed”) toward a state of higher backpressure (“more closed”). A state in which the backpressure of the flow passage is the lowest among all the states of the control valve (there may be more than one such states) may be referred to as a fully open state. A state in which the backpressure of the flow passage is the highest among all the states of the control valve (there may be more than one such states) may be referred to as a fully closed state. A “partially open state” or “partially closed state” refers to a state intermediate between the fully open state and the fully closed state. Unless explicitly specified as partially open or fully open, the terms “open” or “in an open state” denote any state other than fully closed. Similarly, stating that a valve is “at least partially open” indicates the valve denotes any state other than fully closed. Conversely, describing the control valve as “closed” or “in a closed state,” without explicitly specifying partial or full closure, does not necessarily imply a fully closed condition, but may refer to a substantially closed condition sufficient to prevent or substantially prevent discharge of the polymer material for the relevant operational context (e.g., during a non-printing move).

As used herein, the term “nominal state” of the control valve refers to a valve state that is operatively designated for sustaining steady-state material deposition under normal printing conditions, such as when depositing the central portion of a sufficiently long segment where neither valve opening nor valve closure procedures associated with the segment's initiation or completion are invoked. The nominal state may be a predetermined valve position that corresponds to a target material flow rate during deposition, or it may represent a dynamic operating range within which the valve maintains the desired flow characteristics. In embodiments employing closed-loop control, the nominal state may be continuously adjusted in response to sensor feedback—such as pressure, flow rate, or temperature—in order to stabilize extrusion performance. Unless otherwise specified, the nominal state is not limited to a specific physical position of the movable valve element (e.g., needle or shutter), but rather encompasses any state of the valve that achieves consistent material discharge suitable for the intended deposition task. The nominal state may vary based on material properties, printhead geometry, or process phase (e.g., infill vs. perimeter deposition), and may include both partially open and fully open states, provided that they enable the desired extrusion behavior.

As used herein, the terms “extrusion” and “extrude” refer to operation of the pressure-generating mechanism which involves advancement of raw materials within a portion of a polymer processing space of the printhead by the pressure-generating mechanism, and do not necessarily imply discharging of the material from the outlet. For example, when the control valve is in a closed state, the printhead may extrude raw material without discharging it to generate a pressure buildup within the polymer processing space. Analogously, pausing extrusion implies pausing the operation of the pressure-generating mechanism and does not necessarily imply cessation of material discharge from the outlet.

The term “feed rate” refers to the throughput of the pressure-generation mechanism, which depending on the context may be defined either as the mass flow rate of the stream of raw materials within the polymer processing space established by the pressure-generating mechanism, or as a controlled operational parameter of the pressure-generating mechanism that primarily governs said mass flow rate—such as the rotational speed of a screw in a screw extrusion mechanisms, the rotational speed of gears in a filament drive mechanism, or other analogous control parameters.

The 3D printer may employ one or more tool gantries configured to move, without limitation, along a Y direction. The tool gantries may be operably coupled to one or more tool carriages carrying one or more tools. Each tool carriage may be configured to move, without limitation, along an X direction relative to the corresponding tool gantry, such that the one or more tools are movable along the X and Y direction, and optionally along one or more additional directions, such as a Z direction, by motion of the tool carriage.

The tool carriage may include a tool mount for receiving and retaining tools. The tool carriage may include an additional linear axis, further referred to as a tool axis, configured to move the tool mount with retained tool along the Z direction. The tool axis may employ a belt drive for positioning along the Z direction. In embodiments, the tool axis may employ various combinations of a belt drive, a linear motor, a piezo actuator, a voice coil, a lead screw, a ball screw, a rack and pinion actuator, and the like, suitable for positioning the tool mount along the Z direction. The 3D printer may include one or more parking stations, each configured to receive a tool when not in active use. The parking station may include a tool mount for retaining the tool when not in active use. In some embodiments, the parking station may include an actuated locking mechanism or docking assist feature to secure or align the tool when not in active use.

The 3D printer may comprise one or more purging stations (for example, a purging station 160 shown in FIGS. 6A-6E) configured to remove residual material discharged by the printhead and, optionally, clean the nozzle of the printhead. The purging station may comprise a receiver, operably connected to a waste collection tank via a conduit. The waste collection tank may be further operatively coupled to a vacuum pump configured to generate negative pressure, such that purged material deposited into the receiver is drawn through the conduit and collected in the tank.

In some embodiments, a plurality of 3D printers—such as those deployed in a print farm—may be fluidly connected to a centralized vacuum pump configured to serve as a shared source of negative pressure for all purging stations. Optionally, the purging stations of individual 3D printers may also be connected to a central waste reservoir, such that material from each 3D printer is drawn via a conduit into the shared reservoir for collection and disposal.

In some embodiments, the purging station may include a passive or actively actuated wiping mechanism (or referred to as wiping unit). This wiping mechanism may comprise a wiper, such as a blade, wire or brush. The wiper may be fixedly mounted on a base element, such as the receiver, and may be further configured to deform during operation, such as when the wiper is a wire fixedly mounted to the base element with its ends. In some embodiments, the wiper may be mounted for movement using a spring-loaded mechanism, such as a blade attached to the base element using a spring-loaded hinge. In some embodiments, the wiper may be mounted on a high-speed actuator, such as a pneumatic cylinder, solenoid, or servo motor, capable of rapidly accelerating the wiper prior to contacting with the excess material discharged by the printhead. Actively actuating the wiper ensures highly efficient and consistent removal of residual strands or droplets adhering to the nozzle.

In minimal configurations of the purging station, the receiver and conduit may be omitted in favor of a simplified design incorporating only a wiping mechanism and a waste collection tray. In such embodiments, the wiping mechanism may be configured to direct removed excess material into the waste collection tray. For example, an actively actuated wiper may rapidly displace the excess material by knocking or sweeping it into the tray using a rapid motion of the wiper element.

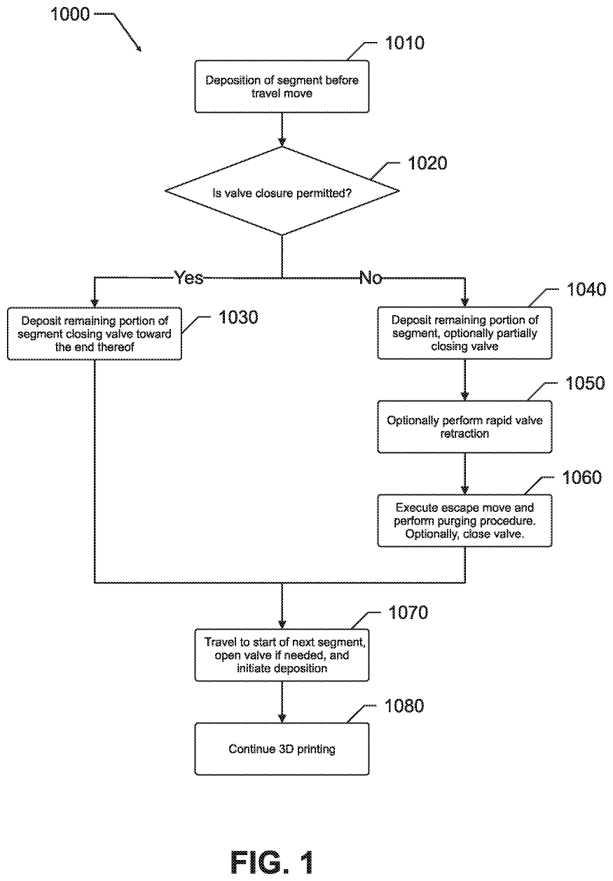

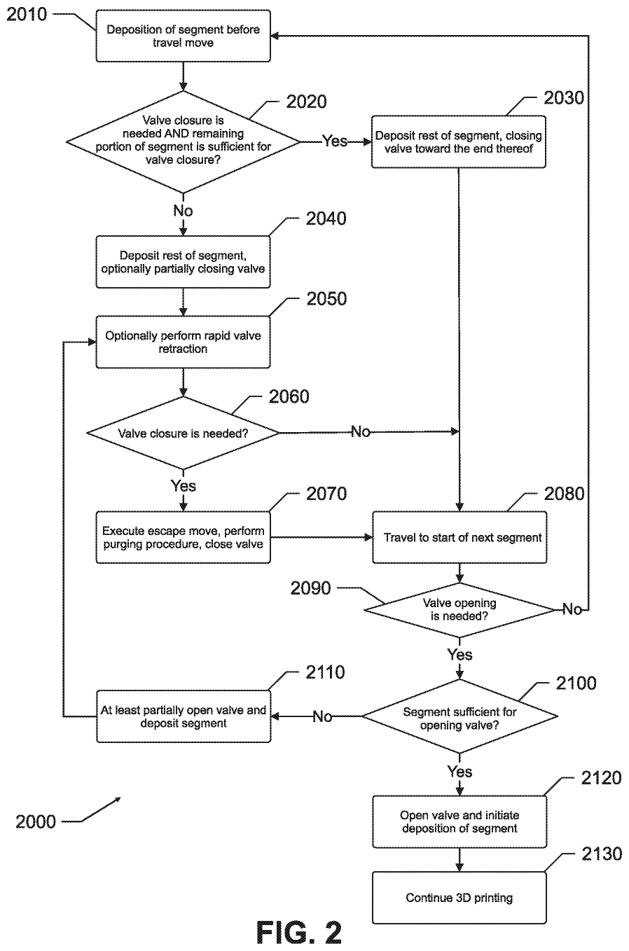

In some embodiments, the purging station may be positioned beneath one or more parking stations, such that printhead may be purged after being parked. The receiver may further be mounted for movement along Z, Y or X directions by an actuator. For example, the receiver may be configured for positioning along the Y axis such that it can be moved closer to the active printhead during operation, thereby facilitating shorter travel moves during a purging procedure (as discussed below in connection with FIGS. 1 and 2), and subsequently returned to its default position beneath the parking station when the printhead is no longer active. In some embodiments, the receiver may be translated toward the active printhead along the Y axis to perform the purging procedure and translated away from the active printhead along the Y axis upon the completion of the procedure. The actuator may be a linear actuator or multi-axis actuator employing various combinations of a belt drive, a linear motor, a lead screw, a ball screw, a rack and pinion, a pneumatic cylinder, a solenoid, a linear motor, a stepper motor, a servo motor, and the like, to provide motion of the receiver in selected directions.

In some embodiments, the receiver may be movable along the Z direction to establish substantial proximity to a nozzle of the printhead during purging operations, thereby improving suction efficiency. Alternatively, or in addition, the tool may be moved toward the receiver along the Z direction by the tool axis. As used herein, “substantial proximity” between the nozzle and the receiver refers to a distance sufficiently small such that the suction force acting on the discharged or residual material is adequate to facilitate consistent and effective removal of the material from the nozzle during 3D printing operations, as would be understood by a person having ordinary skill in the art. Bringing the nozzle and the receiver into substantial proximity, as described herein and elsewhere in this disclosure, may be referred to as bringing the printhead and the purging station into operative proximity; the printhead and the purging station may be brought into operative proximity by motion of the printhead, by motion of the purging station or a component thereof (such as the receiver), or by a combination of such motions.

The purging stations are particularly advantageous in fused granular fabrication (FGF) 3D printing, where pellet-based extruders frequently require purging to prevent thermal degradation of material and to maintain a consistent extrusion process. Purging is critical in sustaining print quality, particularly during material changes, idle periods, or extended print cycles.

In some embodiments, mostly relevant to fused filament fabrication (FFF) with non-foamed materials, where the volumes of excess material are insignificant, the purging stations may have a minimal configuration without suction-assisted waste disposal. For example, the purging station may comprise a brush and a waste reservoir located in close proximity to it. In other embodiments, instead or in addition to brush, the purging station may comprise a spring-loaded blade or wire configured to remove excess material from the nozzle. In general, any configuration of the purging station may be employed as far as it enables to consistently remove the excess material from the printhead during 3D printing.

Referring now to FIG. 1, shown is a flowchart 1000 of a generalized method according to one aspect of the disclosure, illustrating the logic of an adaptive flow control strategy for additive manufacturing systems. Disclosed method is designed for additive manufacturing processes and systems that employ an active control valve to regulate material flow. This high-level representation abstracts away specific implementation details in favor of outlining the key logical stages underpinning controlled material deposition and movement.

In some embodiments, the term “deposition segment,” also referred to simply as a “segment” or as a “print segment,” may refer to a continuous portion of the toolpath along which the printhead is configured to deposit polymer material onto the build surface or onto previously deposited material. A deposition segment has a starting point and an endpoint defined by the toolpath, and may include an initial portion proximate the starting point, a terminal portion proximate the endpoint, and one or more intermediate portions therebetween. The toolpath may comprise a plurality of deposition segments, separated by one or more non-printing moves during which the printhead is configured not to deposit polymer material. A non-printing move may comprise, by way of non-limiting example, a travel move between two deposition segments, an escape move from a deposition segment to a purging station, or a travel move from a purging station to a subsequent deposition segment. A deposition segment may be linear or non-linear, may include changes in deposition direction, and may be of any length consistent with the toolpath.

In some embodiments, a transition from a current deposition segment to a subsequent deposition segment, or referred to herein as a transition between deposition segments or simply as a transition, may refer collectively to the sequence of operations performed by the additive manufacturing system between completion of deposition of the current deposition segment and onset of steady-state deposition of the subsequent deposition segment. Such a transition may comprise, by way of non-limiting example, one or more of (i) valve closure or partial valve closure along a terminal portion of the current deposition segment, (ii) a rapid valve retraction during or immediately preceding completion of the current deposition segment, (iii) an escape move from the current deposition segment to a purging station and a purging procedure performed thereat, (iv) one or more non-printing moves between the current deposition segment, the purging station (where present), and the subsequent deposition segment, and (v) valve opening or partial valve opening along an initial portion of the subsequent deposition segment.

In some embodiments, the method governs the operational state of the printhead, between deposition and non-deposition, in a way that is sensitive to the spatial characteristics of each deposition segment and to each transition between deposition segments. For any given segment, a decision may be made as to whether the segment justifies engaging a normal valve closure protocol, or referred to as a transition protocol. If this condition is satisfied, material is deposited along the remaining portion of the segment, at least partially closing the valve as the endpoint is approached.

Alternatively, if the system determines that the segment does not justify engaging the normal valve closure protocol, the deposition continues up to the endpoint, optionally engaging an alternative valve closure protocol. Upon completion, the printhead may execute an escape non-printing move followed by a purging procedure. This sequence prepares the nozzle for subsequent operations by removing residual material and mitigating unintended discharge during the non-printing transition to the next segment.

Optionally, substantially concurrently with completion of the segment the system may perform a rapid retraction of a needle or any movable valve element within the nozzle, such that the retraction increases the volume of at least a portion (e.g., a downstream portion) of the polymer processing space at a rate sufficient to momentarily interrupt material flow and facilitate clean separation between the deposited segment and the printhead at the onset of the escape move. While flowcharts shown in FIGS. 1 and 2 may illustrate the rapid valve retraction as occurring after deposition of the segment, such representation is for clarity of explanation. In practice, initiation of rapid valve retraction may begin prior to actual completion of the segment. For example, retraction of the movable valve element—executed using pre-defined or dynamically calculated parameters—may be triggered slightly before the segment endpoint to compensate for the time required to accelerate the valve element and attain a speed sufficient to offset the ongoing material flow from the nozzle. The deposition speed profile may be further adjusted to accommodate for a faster cessation of material flow caused by the rapid retraction, e.g., by increased deceleration toward the end of the segment.

In some embodiments, the control valve comprises a movable valve element—such as a valve stem or needle—configured to be introduced into and retracted from a portion of the polymer processing space within the printhead nozzle. The valve element may be shaped to conform to the internal geometry of the nozzle and is operatively positioned to regulate or interrupt material flow through the outlet. To facilitate rapid valve retraction, the valve may be actuated by a high-speed actuator capable of delivering precise motion control and high acceleration. Suitable actuators may include, without limitation, a voice coil actuator, piezoelectric actuator, linear motor, or high-speed servo actuator. These actuator types enable rapid withdrawal of the valve element from the polymer processing space to create a temporary volumetric expansion, thereby enabling flow interruption.

Following completion of the segment—or after execution of the purging procedure—the printhead may be repositioned to the start location of the next segment. Once repositioned, the valve may be opened, and material deposition may resume, thereby continuing the additive manufacturing process.

This logic flow provides a scalable, adaptable framework for managing valve-based material deposition, one that is compatible with a variety of additive manufacturing modalities and operational constraints.

As depicted, the process begins with the deposition of a segment before a travel move (also referred to as a non-printing move) in step 1010. The system then decides whether the segment allows closure of the valve (step 1020). If the segment allows closure of the valve, the system may proceed to deposit the remaining portion of the segment, closing the valve toward the end of the segment (step 1030). Once this deposition is complete, the system may perform a non-printing move to the start of the next segment, open valve and initiate deposition of the next segment (step 1070), after which the 3D printing process continues (step 1080). If the segment does not allow closure of the valve, the system may deposit the rest of the segment, optionally partially closing the valve toward the end of the segment (step 1040). The system may then perform an escape move followed by a purging procedure, and close the valve if called for (step 1060).

The escape move may include vertical movement of the nozzle relative to the segment, for example, by any combination of lowering the build surface and lifting the printhead with a tool axis. In some embodiments, e.g., in infinite-build (belt-type) 3D printers or in other printers in which the build surface is configured to translate along a horizontal axis, the escape move may comprise, in addition to or as an alternative to the vertical movement, moving the build surface laterally relative to the printhead so as to increase the distance between the nozzle and material deposited along the current segment. The vertical movement facilitates separation of the deposited material from the material within the nozzle. The higher accelerations of the vertical movement are beneficial for minimizing an unintended discharge at the end of segment. To further minimize the unwanted discharge and eliminate stringing of the material, the system may optionally perform a rapid valve retraction (step 1050) prior to or concurrently with the escape move. In some embodiments, a wiping movement may be performed at the end of the segment immediately prior to the escape move to further facilitate a clean separation.

In embodiments, the purging procedure may be carried out at a designated purging station. Accordingly, in step 1060, the system may redirect the printhead to the purging station via the escape move. The valve may be closed during travel to the purging station, at the purging station, or during the travel to the next segment. There may be one or more transitions between open and closed valve states, until the valve is finally closed prior to a non-printing move to the subsequent segment. During the escape non-printing move, excess material may be accumulated under the nozzle due to residual pressure or valve displacement. Optionally, prior to closing the valve for the non-printing move to the subsequent segment, at the purging station, the printhead may extrude additional excess material in a controlled manner to stabilize the extrusion process. The purging station may remove the excess material discharged from the nozzle. In some embodiments, the purging station may employ suction to remove the excess material. In such embodiments, without limitation, suction may be activated concurrently with or immediately after closing the valve prior to the non-printing move to the subsequent segment.

Following the purging procedure, the system resumes by traveling to the next segment and reopening the valve if called for (step 1070) for continued printing (step 1080). This sequence ensures adaptive and efficient control over material deposition and valve actuation throughout the additive manufacturing process. In some embodiments, the purging procedure may be minimal and comprise cleaning the nozzle without extruding material from the nozzle.

The general principles outlined in FIG. 1 serve as a conceptual foundation for more detailed control strategies. Building upon this framework, FIG. 2 elaborates an exemplary implementation of the method, incorporating finer decision-making steps and explicit interactions with system components such as the purging station and valve mechanism.

FIG. 2 illustrates a flowchart 2000 of an exemplary method underlying a 3D printing process that involves active valve regulation in conjunction with escape moves and purging procedures. The method governs material flow dynamically during both deposition and travel phases, providing a framework for efficient control while minimizing material loss and maintaining process stability.

The method of FIG. 2 begins with deposition of a segment before a travel move (step 2010), followed by a decision step of whether the valve closure is called for and whether the remaining portion of the segment is sufficient to allow valve closure (step 2020).

The determination of whether valve closure is called for (first condition in step 2020)—whether pre-defined by control system instructions or dynamically evaluated during operation—may be based on various factors, including but not limited to (i) a length of the non-printing move to the subsequent segment, (ii) a duration of the non-printing move to the subsequent segment, (iii) a material flow rate of the polymer material from the nozzle, (iv) an expected volume of polymer material that would be discharged from the nozzle during the non-printing move with the actively controlled valve in an open or partially open state (which expected volume may be derived from, for example, the material flow rate and the duration of the non-printing move), (v) permissible accelerations during the non-printing move, (vi) a material type of the polymer material, (vii) a temperature of the polymer material within the polymer processing space, (viii) a foaming or thermal-expansion characteristic of the polymer material, and combinations of any of the foregoing. For example, valve closure may be deemed not called for, and the non-printing move may be performed with the actively controlled valve in an open or partially open state, when one or more of the foregoing factors is below a respective predetermined or dynamically evaluated threshold (for example, when the expected volume of polymer material that would be discharged from the nozzle during the non-printing move is below a threshold associated with the subsequent deposition segment, or when the length or duration of the non-printing move is below a respective threshold).

The determination of whether the remaining portion of the segment is sufficient to allow valve closure (second condition in step 2020)—whether pre-defined by control system instructions or dynamically evaluated during operation—may be based on various combinations of factors, such as the current state of the valve, the volume of material displaced by the valve from the nozzle during the transition from the current state to a closed state, the volume of material required to deposit the remaining portion of the segment, the length of the remaining portion of the segment, and the like. For example, the segment may be deemed insufficient for valve closure if the combined volume of material displaced by the valve and discharged from the nozzle due to residual pressure during closure exceeds the volume required to complete deposition of the remaining segment. In addition to the factors enumerated above, the volume of material associated with closing the valve may include material displaced or discharged from the polymer processing space due to thermal expansion of the polymer material within the polymer processing space, and material discharged due to continued operation of the pressure-generating mechanism during all or part of the valve closure. The determination of whether the remaining portion of the segment is sufficient to allow valve closure may also accommodate a permitted over-deposition tolerance, such that the segment may be deemed sufficient even when the combined volume of material displaced and discharged during valve closure modestly exceeds the volume of the remaining portion of the segment, provided that the excess does not exceed a permitted threshold associated with print-quality requirements for the segment.

If both conditions in step 2020 are met (the valve closure is called for and the remaining portion of the segment is sufficient to allow valve closure), the printhead deposits the rest of the segment while closing the valve toward the end thereof (step 2030) and performs a travel move to the start of the next segment (step 2080).

If at least one condition in step 2020 is not met (the valve closure is not called for or the remaining portion of the segment is not sufficient to allow valve closure), the printhead deposits the rest of the segment while optionally partially closing the valve (step 2040). Optionally, the printhead may perform a rapid valve retraction (step 2050) at the end of the segment. If the valve closure is not called for (step 2060), the printhead proceeds to the next segment (step 2080). If the valve closure is called for (step 2060), the printhead performs an escape move followed by a purging procedure, and closes the valve (step 2070), as discussed in connection with FIG. 1.

If valve opening at the start of the next segment is called for (step 2090), the method proceeds to a decision step 2100 of whether the next segment is sufficient to allow opening the valve; if so, the valve is opened while depositing the initial portion of the next segment (step 2120), and the process continues with 3D printing (step 2130).

If the next segment is not sufficient to allow opening the valve (step 2100), the system at least partially opens the valve while depositing material until the end of the next segment (step 2110), optionally followed by a rapid valve retraction (step 2050), as discussed in connection with FIG. 1. If the valve closure is not called for (step 2060), the printhead proceeds to a next segment (step 2080), and continues to deposit material, while further opening the valve if called for. Transitioning to a nominal valve state may take several segments until normal operation continues (step 2130). If the valve closure is called for (2060), the printhead performs the escape move followed by the purging procedure, and closes the valve (step 2070), as discussed in connection with FIG. 1. Some embodiments may employ an alternative step 2070 without closing the valve. For example, when incorporating purging towers (as discussed below) into the purging procedure, the printhead may print a portion of the purge tower in close proximity to the part after the escape move such that the printhead can travel toward the next segment of the part without closing the valve.

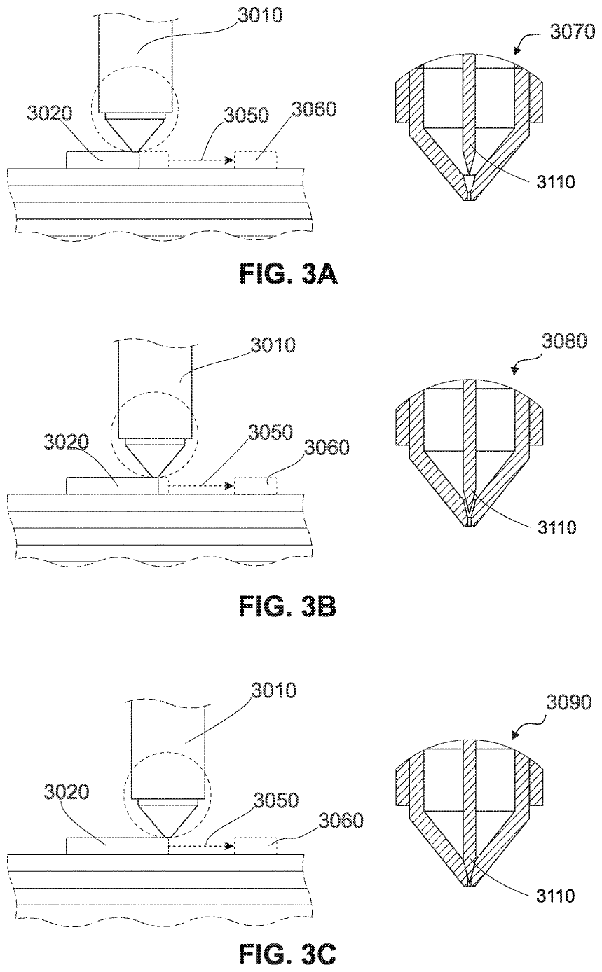

In embodiments, deposition of a segment may be completed with the valve being progressively closed toward the end thereof, such that the material displaced by the valve during valve closure is deposited within the segment. For example, such technique may be used in steps 1030 and 2030. Upon completion of deposition, the system may transition to the next segment, which may involve a non-printing travel move. An example of such process is illustrated in FIGS. 3A-3C.

FIG. 3A shows a printhead 3010 with a needle valve depositing a segment 3020 in preparation for an upcoming non-printing move 3050 to the next segment 3060, with cross-section 3070 indicating that the valve is in the nominal state. FIG. 3B depicts the printhead 3010 during the valve closure process, continuing to deposit segment 3020 while progressively closing the valve by moving the needle 3110 closer toward a fully closed state in preparation for the non-printing move 3050, with cross-section 3080 showing the valve in a partially closed state. FIG. 3C illustrates the printhead 3010 immediately after completing deposition of segment 3020 and preparing to execute the non-printing move 3050 to the next segment 3060, with cross-section 3090 showing the valve in a closed state. This enables precise interruption of material discharge prior to non-printing movement.

During the process illustrated in FIGS. 3A-3C, the feed rate, deposition speed, and valve state (also referred to as valve position) may be controlled in various ways. In an exemplary approach, extrusion is substantially reduced or paused concurrently with the initiation of valve closure in order to minimize the volume material discharged during valve closure, thereby enhancing the fidelity of the three-dimensional (3D) printing process. In some embodiments, the valve closure may be accelerated toward the end of the segment to compensate for the declining residual pressure in the polymer processing space, thereby maintaining a deposition rate consistent with intended printed geometry. Alternatively, or in combination with said acceleration, deposition rate consistency may be maintained by decelerating the deposition speed during valve closure toward the end of the segment.

In some embodiments, extrusion may instead continue during the valve closure process—or for a portion of the time during which the valve is being closed—and, optionally, during the subsequent non-printing move 3050. In such cases, the feed rate and deposition speed may follow an adjusted profile, e.g., declining toward the end of the valve closure. Such approaches may be beneficial to maintain process consistency, particularly when printing with highly thermally sensitive materials.

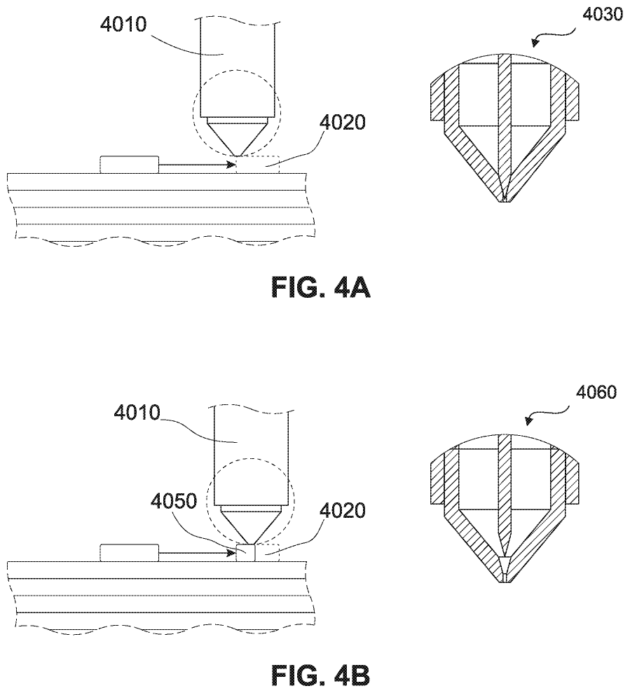

FIG. 4A illustrates an exemplary process, where printhead 4010 initiates deposition of a segment 4020 upon performing a travel move with a closed valve. The printhead 4010 comprises a needle valve, with cross-section 4030 indicating that the valve is closed. FIG. 4B depicts the subsequent moment, after the printhead 4010 advanced along the segment 4020 and deposited its initial portion 4050, with cross section 4060 showing the valve opened to a nominal state. If the segment is determined as insufficient to permit full valve opening, for example, in step 2100, the valve may instead be partially opened in coordination with deposition of the segment, for example, as described in connection with step 2110.

In some embodiments, deposition of an initial portion 4050 of the segment 4020 may be performed with the valve progressively opened along with the deposition of the initial portion 4050. This approach may be particularly beneficial for mitigating over-extrusion at the beginning of the segment during 3D printing processes involving in-situ foaming, since during a non-printing move the ongoing foaming process may generate a pressure buildup within the nozzle, resulting in a rapid discharge from the nozzle immediately after valve opening is initiated. For example, such technique may be used in steps 1070, 2110 and 2120.

The feed rate during deposition of the initial portion 4050 may follow various profiles. In embodiments where extrusion is paused prior to the deposition of the initial portion 4050, the onset of extrusion may occur at any point prior to the beginning of valve opening, during the opening process itself, or after the valve reaches its nominal state. In some embodiments, the onset of extrusion may occur substantially concurrently with opening the valve to its nominal state. Upon the onset, the feed rate may be reinstated substantially instantaneously or follow a gradual feed rate profile. In some embodiments, e.g., employing high-speed motion systems, the feed rate may be maintained substantially constant throughout the travel move and the deposition of the initial portion 4050.

In embodiments, the deposition speed may be gradually increased throughout the opening process to compensate for reduced flow rate from the nozzle at the onset of deposition of the segment 4020 that the deposition rate remains consistent with the intended printed geometry. The reduced flow rate may result from a pressure lag, which in turn may be caused by various factors, including preliminary cessation of extrusion prior to completion of the previous segment, displacement of material from the nozzle during valve closure, or melting of the material within the polymer processing space. The pressure lag may be reduced by onsetting the extrusion slightly prior to the beginning of valve opening. The reduced flow rate may be also due to a higher backpressure of a partially closed valve.

In some embodiments, deposition of an initial portion of a segment, such as in steps 1070 and 2110, may be performed with a valve being opened prior to the beginning of deposition. For example, the valve may be opened as the printhead approaches the segment during a non-print move from the previous segment or a purging station. As another example, the valve may be opened at the beginning of the segment. The onset of extrusion may occur at any point prior to the beginning of valve opening, during the opening process itself, or after the valve is opened to the nominal state.

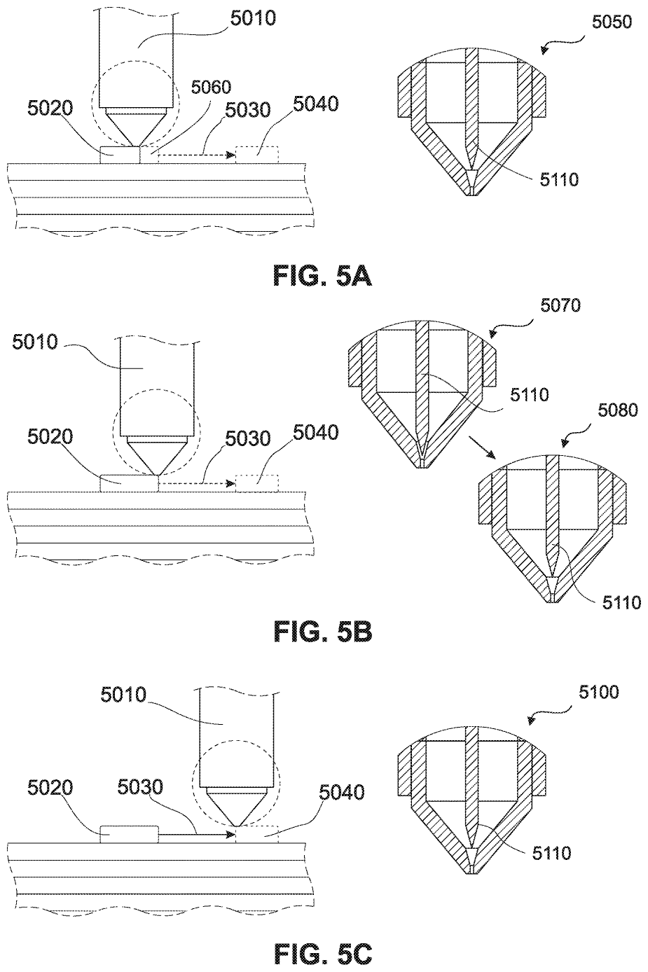

FIGS. 5A-5B show an exemplary process in which a printhead 5010 deposits a remaining portion 5060 of a segment 5020 prior to transitioning to the next segment 5040. In this example, the segment 5020 is determined to be insufficient for full valve closure. The printhead 5010 includes a needle valve configured to regulate material flow.

In some embodiments, such a scenario may be handled by partially closing the valve toward the end of the segment 5020. FIG. 5B depicts the printhead 5010 at the end of segment 5020, immediately after the completion of deposition thereof. Because segment 5020 is insufficient to accommodate full valve closure, the valve may be progressively closed to a partially closed state during deposition of the remaining portion 5060. This approach is illustrated in cross-section 5070, which shows the valve in a partially closed state at the segment's end.

In some embodiments, the valve may remain in a fully or partially open state at the end of a segment. For example, if the distance of the travel move to the next segment is too short to exceed a pre-defined or dynamically evaluated threshold (such as when the first condition in step 2020 is FALSE and step 2060 is FALSE), the printhead may complete deposition of the remaining portion of the segment (as in step 2040) and execute the travel move with the valve maintained in the nominal state (as in step 2080).

Optionally, substantially concurrently with completion of segment 5020, a rapid valve retraction may be performed, as illustrated by the transition from cross-section 5070 to cross-section 5080, wherein the needle 5110 is rapidly retracted from a less open state to a more open state. The initiation of rapid valve retraction may begin prior to the completion of the segment 5020. For example, retraction of the needle 5110—executed using pre-defined or dynamically calculated parameters—may be triggered slightly before the segment 5020 endpoint to compensate for the time required to accelerate the needle 5110 to a speed sufficient to offset the ongoing material flow through the nozzle. The deposition speed profile may be further adjusted to accommodate for a faster cessation of material flow caused by the rapid retraction of the needle 5110, e.g., by a faster deceleration toward the end of the segment 5020.

Throughout the present disclosure, the term rapid valve retraction refers to the withdrawal of a movable valve element from a portion of the polymer processing space within the nozzle with sufficient acceleration and over an adequate travel distance to momentarily interrupt the material flow, thereby enabling a clean separation between the deposited segment and the printhead at the onset of the escape move.

The required acceleration and travel distance for rapid valve retraction may be determined based on parameters including, but not limited to: the cross-sectional area of the movable valve element within the nozzle; the maximum permissible acceleration and travel of the valve element; the volumetric extrusion flow rate from the nozzle; and the maximum allowable acceleration of the printhead. Examples illustrating the calculation of acceleration and travel distance under various parameter sets are provided in the Examples section of the present disclosure.

FIG. 5C illustrates a scenario in which the printhead 5010 completes the non-printing move 5030 with the valve in a partially or fully open state—for example, if step 2060 evaluates as FALSE—prior to initiating deposition of the next segment 5040, as shown in cross-section 5100. Alternatively, if travel with an open valve is not permitted—for example, if step 2060 evaluates as TRUE—the system may execute an escape move followed by a purging procedure, as described in connection with FIGS. 1 and 2.

A similar decision process applies when evaluating the possibility of opening the valve to the nominal state for the next segment. If the segment length is insufficient for complete valve opening, a modified opening protocol may be used, with extrusion initiated under partial valve opening or other suitable conditions.

The described logic may be repeated for each successive segment of the toolpath, enabling adaptive control of valve actuation in response to the geometric and process-related parameters of the printing operation.

In certain embodiments, the system may be configured with a predefined limit on continuous extrusion, expressed for example as a maximum uninterrupted extrusion length or volume. Upon reaching or exceeding this threshold, the system may redirect the printhead to a purging station, where a controlled extrusion of material is carried out to stabilize the extrusion process—optionally with vacuum assistance—followed by valve closure. This approach may serve to prevent degradation of material and maintain consistent printing quality.

In other embodiments, a threshold may be defined for the number of valve actuations within a specified time interval. If this limit is exceeded, the system may similarly initiate a purging procedure by directing the printhead to the purging station. This functionality may reduce mechanical wear on the valve components and help stabilize flow dynamics, particularly in cases involving frequent transitions between open and closed valve states.

In some embodiments, the system may also be configured with a minimum extrusion threshold for a single layer, defined in terms of material volume or deposition length. If this threshold is not met during the course of printing a given layer, the system may initiate a purging procedure by directing the printhead to the purging station. This ensures sufficient material flow is maintained within the printhead and helps prevent issues related to under-extrusion or nozzle clogging during subsequent layers.

Referring now to FIGS. 6A-6E, depicted is an exemplary procedure for executing an escape move followed by a purging procedure in an exemplary additive manufacturing system. The system as shown comprises dual tool gantries 101L, 101R, a printhead 110A mounted on a tool axis 107R, an insulated build chamber 130, and a purging station 160. FIG. 6A illustrates the deposition of a segment of a printed part 180 prior to initiating the escape move.

FIG. 6B depicts the printhead 110A performing the escape move towards the purging station 160. During this maneuver, the printhead 110A moves horizontally within the X-Y plane while being raised along the Z-axis using the tool axis 107R. Alternatively or additionally, the build surface 131 may be moved along the Z-axis to separate the nozzle 120 from the printed part 180. Residual pressure within the nozzle 120 during this escape move, while the valve is at least partially open, may result in the formation of a residual strand 165 of discharged material extending from the nozzle 120.

As shown in FIG. 6C, the printhead 110A exits the insulated build chamber 130 via an access window 140. The access window 140 may be sealed by a movable cover 138, which opens upon contact with an extension 136 of the X tray 103R as the printhead moves through the window. Alternative implementations may incorporate active actuators such as solenoids, pneumatic cylinders, or electric motors to operate the cover 138. In certain embodiments, flexible seals such as brush seals or elastic flaps may replace the movable cover 138, facilitating unhindered nozzle passage. In certain embodiments, for instance when the insulated chamber primarily contains debris from subtractive processes, the access window 140 may remain permanently open.

Upon reaching the purging station 160, illustrated in FIG. 6D, the nozzle 120 may align with a receiver 161. The system may initiate controlled extrusion of purge material from the nozzle 120, with the valve set in a partially or fully open state. The purge extrusion flow rate may be selected from various profiles—for example, reduced, nominal, or increased—depending on the purging objective, such as routine nozzle maintenance, aggressive clearance of residual material, or reestablishment of stable extrusion conditions. In some embodiments, the final purging phase returns extrusion flow to nominal conditions to ensure consistent extrusion in subsequent printing tasks.

As illustrated in FIGS. 6A-6E, the receiver 161 may be connected to a waste collection tank 162 via a conduit 163. The waste collection tank 162 may be further operatively coupled to a vacuum pump configured to generate negative pressure, such that purged material deposited into the receiver 161 is drawn through the conduit 163 and collected in the tank 162. As shown, the receiver 161 may include an entry port defined by an edge 164 which is fluidly connected to the waste tank 162 via the conduit 163.

The printhead 110A or the receiver 161 may further be mounted for vertical movement to establish substantial proximity between the nozzle 120 and the receiver's entry port for efficient removing of discharged material, such as the residual strand 165. FIG. 6E illustrates the printhead 110A lowered toward the entry port by the tool axis 107R such that the edge 164 achieves substantial proximity to the nozzle 120. This arrangement significantly improves suction efficiency, enables reliable cleaning, and reduces thermal disturbances on the upstream heating zones of the printhead 110A. Alternatively, or in addition, the receiver 161 may be actuated along the Z axis to establish substantial proximity between the entry port and the nozzle 120. In some embodiments, the receiver 161 may have a plurality of entry ports fluidly connected either to a shared or separate conduits 163. The purging station 160 may include a valve system configured to selectively fluidly connect the entry ports to the vacuum pump. The entry ports may differ in size, with larger ports configured for removing bulk discharged material at the beginning of purging, and smaller ports configured for removing residual material from the nozzle 120 by generating higher airflow velocities through the narrow gap between nozzle 120 and edge 164. As used herein, “substantial proximity” between the nozzle and the entry port refers to a distance sufficiently small such that the suction force acting on the discharged or residual material is adequate to facilitate consistent and effective removal of the material from the nozzle during 3D printing operations, as would be understood by a person having ordinary skill in the art.

In some embodiments, the purging station may include a passive or actively actuated wiping mechanism. This wiping mechanism may comprise a wiper, such as a blade, wire or brush, configured to remove residual material from the nozzle 120. The wiper may be fixedly mounted on a base element, such as the receiver 161, and may be further configured to deform upon contract with the nozzle 120 during operation, such as when the wiper is a wire fixedly mounted to the base element with its ends. In some embodiments, the wiper may be mounted for movement using a spring-loaded mechanism, such as a blade attached to the base element using a spring-loaded hinge. In some embodiments, the wiper may be mounted on a high-speed actuator, such as a pneumatic cylinder, solenoid, or servo motor, capable of rapidly accelerating the wiping element prior to contacting with the residual strand 165. Actively actuating the wiper ensures highly efficient and consistent removal of residual strands or droplets adhering to the nozzle. In some embodiments, the entry port itself may function as a wiper. For instance, when the receiver 161 is actuated in the X-Y plane, the printhead 110A may lower the residual strand 165 into the entry port before the receiver 161 moves laterally to separate the strand 165 from the nozzle. Alternatively, the receiver 161 may clean the nozzle 120 by scraping it with the edge 164 as the nozzle 120 moves downward along the Z-axis toward the entry port. In some embodiments, a cutting laser or directed air flow may be configured to operate as a wiping mechanism, separating the residual strand 165 from the nozzle 120.

In some embodiments, the purging station 160 may be fully or partially mounted on an X tray 103. For example, the purging station 160 may comprise a receiver 161 mounted on an X tray 103 and configured to move together with the printhead 110A in the X-Y plane. The conduit 163 may be routed to follow the movement of the receiver 161 as it moves with the printhead 110A in the X-Y plane. In such configurations, the escape move—described in connection with FIGS. 1 and 2—may involve lifting the printhead 110A along the Z-axis via the tool axis 107 to establish substantial proximity between the nozzle 120 and the entry port of the receiver 161. Additionally, the receiver 161 may be movably mounted on the X tray 103 and operably coupled to an actuator configured to align the receiver 161 with the nozzle 120 to facilitate the collection of discharged material, such as the residual strand 165. In some embodiments, the purging station 160 may comprise a passive or actively actuated wiping mechanism mounted on the X tray 103, either in addition to or instead of the receiver 161.

In some embodiments, where the X tray 103 or Y tray 104 is selectively engageable with, respectively, a tool carriage 102 or a tool gantry 101, alignment of the receiver 161 with the nozzle 120 may be accomplished by first disengaging the X tray 103 (and optionally the Y tray 104), and then moving the printhead 110A relative to the X tray by moving the tool carriage 102 or the gantry 101. In embodiments incorporating a wiping mechanism mounted on the X tray 103, the same principle may be applied for establishing contract between the nozzle 120 and the wiper by moving the nozzle 120 relative to the wiper. In some embodiments with components of the purging station 160 mounted on the X tray 103, the receiver 161 and conduit 163 may be omitted in favor of a simplified arrangement comprising only a wiping mechanism and a waste collection tray mounted on the X tray 103.

In some embodiments, before starting to deposit a subsequent segment, the printhead may proceed to printing a sacrificial structure, commonly referred to as purge tower, on the build surface 131 or a dedicated surface within the printer's workspace. The purge towers may be incorporated for certain phases of the 3D printing process, such as when the active tool is being changed, to collect extruded material to prime the new active printhead prior to deposition on the actual part 180 (which in embodiments can also be done using the purging stations). The purge towers may also be incorporated into the purging procedures described in connection with FIGS. 1 and 2. Each layer of the purge tower may be deposited concurrently with layers of the actual printed part 180, maintaining stable extrusion conditions throughout the build process. The purge tower may feature internal voids or perimeter walls configured to capture and isolate residual strands or purge waste, thus preventing contamination of the primary printed object. Such towers may further facilitate nozzle wiping or thermal management by serving as integrated tip-wiping or thermal-shielding structures, thereby ensuring high print quality and operational reliability. When using a purge tower in conjunction with steps 1060 and 2110, the valve may be closed at the end of depositing each layer or segment of the purge tower.

The control system 150, shown schematically in FIGS. 6A-6E, may be configured to control the operation of the additive manufacturing system 6000 and its constituent subsystems, including, by way of non-limiting example, the printhead 110A and any further printheads (such as 110B, 110C), the positioning system (including without limitation the tool gantries 101L, 101R, the tool carriages 102L, 102R, and the tool axes 107), the actively controlled valve and its actuator, the pressure-generating mechanism, the purging station 160 (including the receiver 161, the conduit 163, the waste collection tank 162, and any vacuum source operably connected thereto), the access window cover 138 and any actuator associated therewith, and any wiping mechanism, heating elements, cooling elements, sensors, and metrology instruments forming part of the system. The control system 150 may comprise on/off switches, motion-control circuitry, valve-position controllers, feed-rate controllers, temperature controllers, purge controllers, safety interlocks, user-interface devices, and any combination thereof. For example, the control system 150 may be configured to manage the motors and other actuators that drive the positioning system, the actuator that actuates the movable valve element of the actively controlled valve, and the motor or other actuator that drives the pressure-generating mechanism, so as to coordinate motion, extrusion, and valve actuation in accordance with the toolpath and the selected transition protocol.

The control system 150 may acquire the operational data needed to coordinate the additive manufacturing process from one or more of the following sources, alone or in any combination: the machine-control instructions themselves, which may encode the toolpath, segment lengths, expected segment volumes, valve-position setpoints, feed-rate setpoints, escape-move timing, and purging-procedure parameters, all pre-computed by an upstream slicer, CAM system, or cloud-based processing system as described elsewhere in the present disclosure; the internal state of the control system 150 itself, including its current command queue, elapsed times since initiation of a current deposition segment or non-printing move, and the commanded positions of the positioning system, the actively controlled valve, and the pressure-generating mechanism; values computed by the control system 150 (or by an upstream computing system) from the foregoing, including, by way of non-limiting example, an expected volume of polymer material that would be discharged from the nozzle during a non-printing move (computed, for example, from a commanded flow rate and an expected duration of the non-printing move); and/or sensor feedback as described elsewhere in this disclosure, including sensor feedback comprising pressure, flow rate, or temperature for closed-loop adjustment of the nominal state of the actively controlled valve, the pressure-generating mechanism, or both, in order to stabilize extrusion performance. The control system 150 may operate in a substantially deterministic mode in which it executes pre-computed instructions with minimal or no real-time sensor-based decision making, in a closed-loop mode in which sensor feedback is used to adjust operation in real time, or in a hybrid of these modes. Operational decisions described elsewhere in the present disclosure—including the determination of whether valve closure is called for, the determination of whether a terminal portion of a deposition segment is sufficient to accommodate an expected excess discharge volume, and the selection of a transition protocol from among the plurality of transition protocols—may be performed by the control system 150 based on the foregoing data sources, may be pre-determined by an upstream slicer or CAM system and encoded in the machine-control instructions, or any combination thereof.

The control system 150 may include memory and one or more processors. The memory may store instructions for running one or more applications or modules on the one or more processors. For example, the memory may be used in one or more embodiments to house all or some of the instructions called for to implement the functionality of sensor data retrieval, communications with other components of the additive manufacturing system 6000 (e.g., the positioning system, the actively controlled valve and its actuator, the pressure-generating mechanism, the purging station 160, and sensors configured to monitor operation-related information), generation of motion-control, valve-position, feed-rate, and purge commands, execution of transition protocols as described elsewhere in the present disclosure, and the like. The processor or processors may execute the instructions to implement the foregoing functionality.

In some embodiments, the memory of the control system 150 may include any device, mechanism, or populated data structure used for storing information. The memory may encompass, without limitation, any type of volatile memory, nonvolatile memory, and dynamic memory. For example, the memory may comprise random access memory, memory storage devices, optical memory devices, magnetic media, hard drives, solid-state drives, flash memory devices, SIMMs, SDRAM, RDRAM, DDR RAM, SODIMMs, EPROMS, EEPROMs, compact discs, DVDs, and the like. In some embodiments, the memory may include one or more disk drives, one or more databases, one or more tables, one or more files, local cache memories, processor cache memories, relational databases, flat databases, and the like. Those of ordinary skill in the art will appreciate that many additional devices and techniques for storing information may be used as memory. The memory may store, by way of non-limiting example, the machine-control instructions, sensor data, transition-protocol parameters, calibration data, valve and pressure-generating-mechanism parameters, toolpath data, and process-monitoring logs.

The processor or processors of the control system 150 may include one or more programmable processors executing one or more computer programs to perform functions by operating on input data and generating output. The processor or processors may also be implemented as, or include, special-purpose logic circuitry, for example a field programmable gate array (FPGA) or an application-specific integrated circuit (ASIC). The processor or processors may include both general-purpose and special-purpose microprocessors, and any one or more processors of any kind of digital computer. By way of non-limiting example, the control system 150 may include a programmable logic controller (PLC) or a similar programmable controller. The PLC or other processor may process input data from the sensors and execute predefined or dynamically updated control algorithms to coordinate motion, extrusion, valve actuation, and purging, ensuring that the additive manufacturing system 6000 responds appropriately to varying operational conditions, including without limitation variations in material properties, segment geometry, deposition rate, and ambient conditions.

The control system 150 may communicate with one or more components of the additive manufacturing system 6000, and with one or more external computing systems, via one or more communication links. As shown in FIGS. 6A-6E, the control system 150 may communicate over a communication link 152. The communication link 152 may include one or more wireless communication links, including, by way of non-limiting example, the Internet, a mobile data or voice network (e.g., a 5G or Long Term Evolution (LTE) network), a Wi-Fi network, a short-range wireless network (e.g., Bluetooth or Near Field Communication (NFC)), a satellite communication path, a free-space optical communication path, or any other suitable wireless communication network or combination of wireless communication networks. Alternatively, or in addition, The communication link 152 may include one or more wired communication links, which may include, by way of non-limiting example, an Ethernet link, a fiber-optic link, a serial communication link (e.g., USB, RS-232, or RS-485), a controller-area-network (CAN) bus, an industrial fieldbus, or a backplane interconnect. The communication link 152 may separately or together include one or more communication paths supporting Internet Protocol-based communication, real-time motion-control protocols, and time-synchronized control protocols. The control system 150 may include additional communication paths linking a plurality of hardware, software, and firmware components operating together. For example, the control system 150 may be implemented by a plurality of computing platforms, including local controllers mounted on or within the additive manufacturing system 6000 and one or more remote computing platforms (such as a cloud-based platform) communicating with the local controllers over the communication link 152, operating together as the control system 150.

The control system 150 may be connected to or integrated with, via one or more wired or wireless communication links including the communication link 152, a network of sensors, an upstream slicer or computer-aided manufacturing (CAM) system, a cloud-based processing system, a factory or print-farm management system, a production-scheduling system, a materials-management system, a quality-management system, or any combination thereof. Such integration may enable automated operation of the additive manufacturing system 6000 as part of a larger logistical or production workflow, including coordination among a plurality of additive manufacturing systems in a print farm (for example, as described in connection with the centralized vacuum source and centralized waste reservoir elsewhere in the present disclosure), scheduling of fabrication jobs across a fleet of additive manufacturing systems, and centralized monitoring of process parameters and print quality.

The control system 150 may incorporate one or more safety mechanisms, including, by way of non-limiting example, emergency-stop inputs, thermal overload alerts, current and torque overload alerts, vacuum-loss alerts, access-window or chamber-interlock alerts, automatic shutdown protocols triggered by malfunction or unsafe operating conditions, and watchdog timers that detect loss of communication with one or more components of the additive manufacturing system 6000. Upon detecting an unsafe condition, the control system 150 may take appropriate corrective action, including without limitation closing the actively controlled valve, halting operation of the pressure-generating mechanism, returning the printhead 110A to a safe position (such as a parking station), powering down heating elements, and notifying an operator via a user interface or via a remote computing system over the communication link 152.

### EXAMPLES

The present disclosure is more particularly described in the following examples that are intended as illustrations only, since numerous modifications and variations within the scope of the present disclosure will be apparent to those skilled in the art.

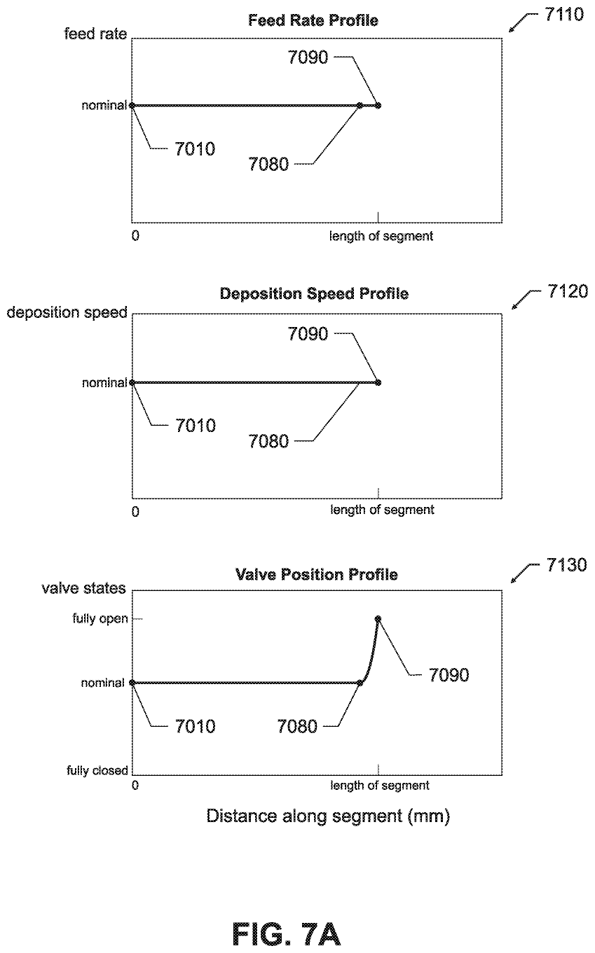

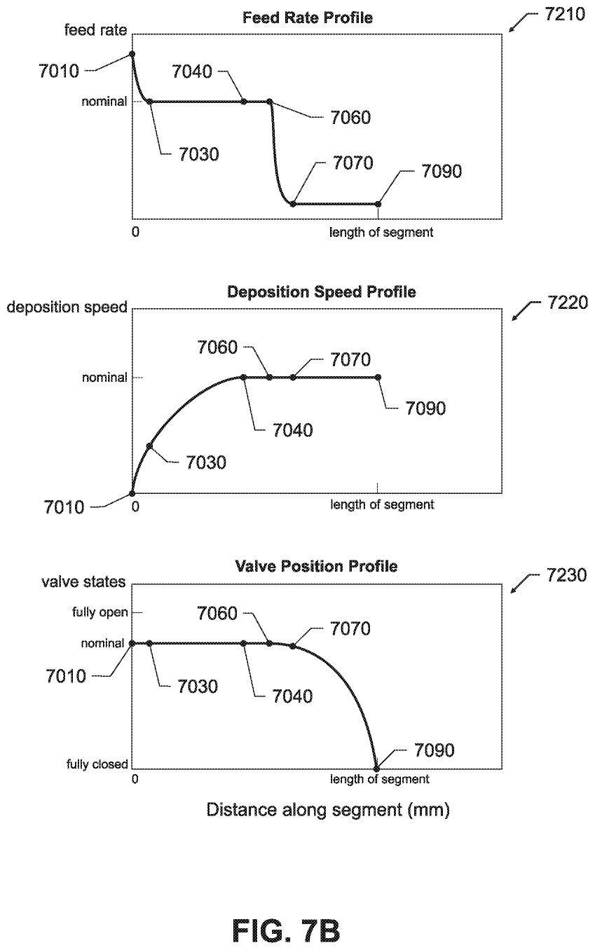

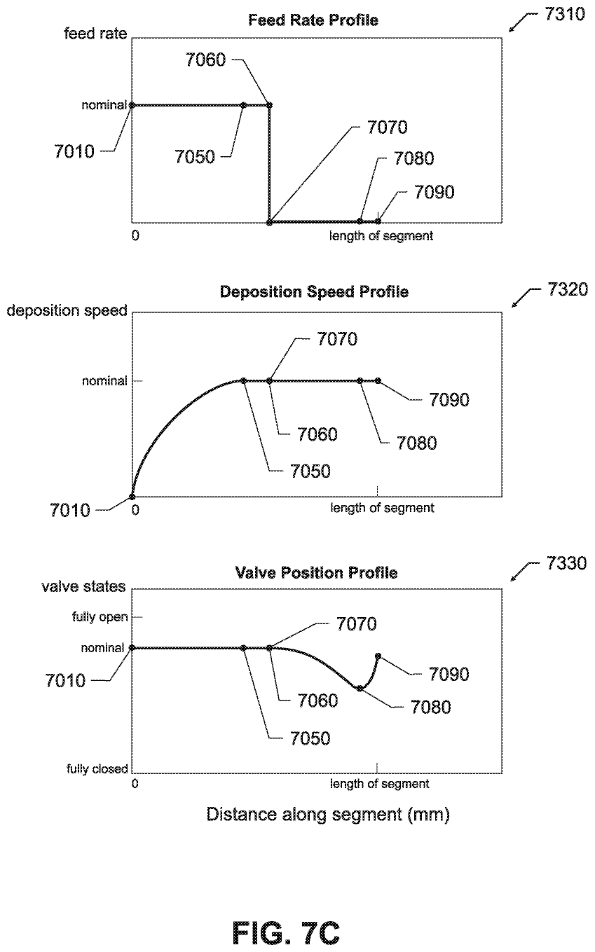

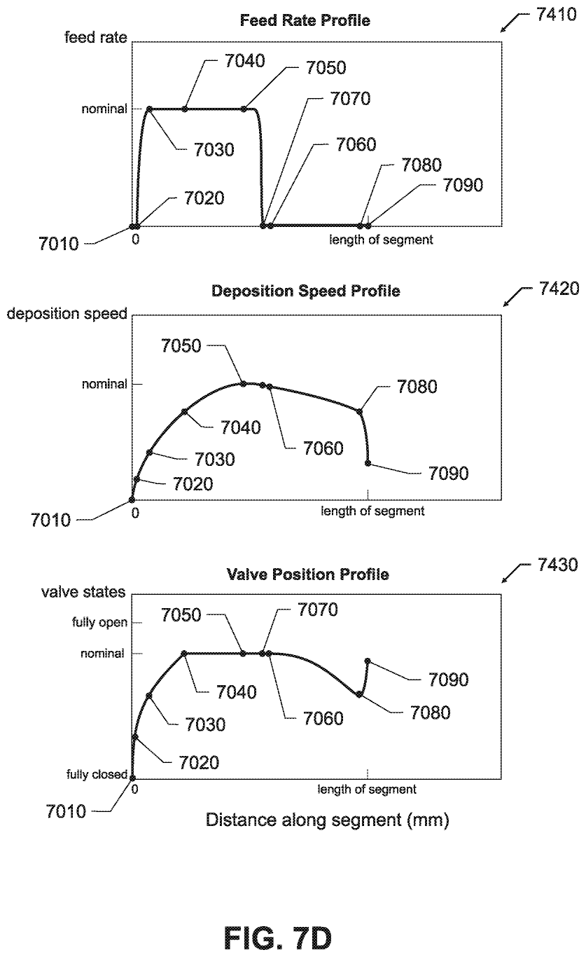

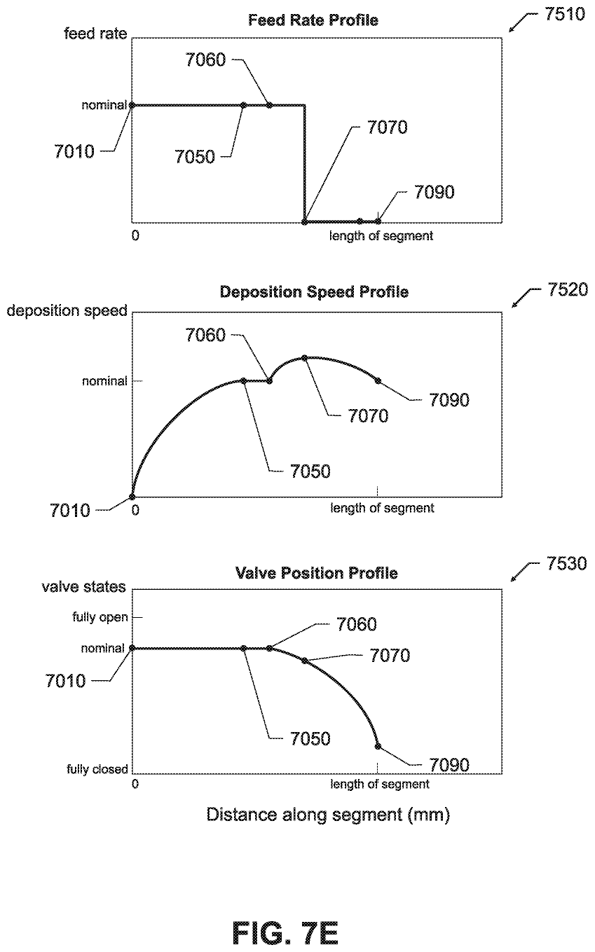

FIGS. 7A-7E depict graphs of deposition speed, extrusion feed rate, and valve position during the deposition of a segment. The horizontal axis of each graph represents the distance from a starting point of a tool path corresponding to the segment, measured in millimeters (mm). The end of the segment is indicated on the horizontal axis of each graph by a point labeled “length of segment.”

The vertical axes of the feed rate profile graphs (7110, 7210, 7310, 7410, and 7510) represent extrusion feed rate, which may be measured in mm/s for filament drive mechanisms, degrees/s for screw extrusion mechanisms, or in units of mass flow rate (e.g., kg/s) for a general pressure-generating mechanism. A nominal feed rate corresponds to a target steady-state feed rate, which may remain constant or vary dynamically during the manufacturing process.

The vertical axes of the deposition speed graphs (7120, 7220, 7320, 7420, and 7520) represent the movement speed of the nozzle relative to the printed part along the tool path, expressed in mm/s.

The vertical axes of valve position profile graphs (7130, 7230, 7330, 7430, and 7530) represent the state of the valve during the deposition process, ranging from a fully closed to a fully open. Valve position may be expressed in millimeters (mm), degrees, or other units suitable for representing the state of the valve. For example, the valve state may be defined by the distance between a needle and a valve seat, or by the stroke length of a linear actuator configured to position the movable element of the valve. Each graph includes an indicated point corresponding to the nominal valve state, which denotes the valve's steady-state open condition, as previously described in the present disclosure.

For purposes of describing the exemplary processes illustrated by FIGS. 7A-7E, the following events of the deposition process are specifically identified and annotated on the graphs: initiation of deposition (7010), initiation of extrusion (7020), reinstatement of nominal feed rate (7030), reinstatement of nominal state of the valve state (7040), reinstatement of nominal deposition speed (7050), initiation of valve closure (7060), interruption of extrusion (7070), initiation of rapid valve retraction (7080), and completion of deposition (7090).

### Example 1 (Calculation of Rapid Valve Retraction Parameters)

Calculation of rapid valve retraction parameters based on exemplary set of valve and process parameters is provided herein. The printhead comprises a needle valve with a needle having a portion of constant diameter with tapered end disposed within the nozzle.

The parameters for four exemplary cases are summarized in Table 1 below. These include: the diameter of the needle, the maximum permissible acceleration and speed of the needle, the available retraction stroke, and the volumetric extrusion flow rate from the nozzle. The volumetric flow rate may correspond to the conditions at or preceding the end of a segment, and may be lower than the nominal flow rate during normal deposition—such as in scenarios where extrusion is paused or reduced in anticipation of the end of the segment.

TABLE 1

| | Needle | Max Valve | Max Needle | Available | Extrusion |
|---|---|---|---|---|---|
| | Diameter | Acceleration | Speed | Stroke | Flow Rate |
| Case | d (mm) | a (mm/s²) | (mm/s) | (mm) | Q (mm³/s) |
| 1 | 2.0 | 5000 | 50 | 1 | 50 |
| 2 | 3.0 | 1000 | 25 | 0.5 | 150 |
| 3 | 1.0 | 5000 | 50 | 2 | 50 |
| 4 | 2.0 | 1000 | 200 | 5 | 500 |

For each case, the following parameters are computed:

Cross-sectional area of the needle:

A=π×(d/2)² (Equation 1)

The needle retraction speed to offset extrusion flow:

v=Q/A (Equation 2)

The retraction distance to reach that speed under the specified acceleration:

ΔL=v²/(2a) (Equation 3)

Case 1. With a 2.0 mm needle, 5000 mm/s² valve acceleration, and 50 mm³/s flow rate, the area is approximately 3.14 mm². The required retraction speed is about 15.9 mm/s, and the distance required to reach this speed is approximately 0.025 mm. Since the distance is less than available stroke which is 1 mm and the retraction speed is less than the maximum needle speed, a rapid retraction can be performed.

Case 2. With a 3.0 mm needle and 150 mm³/s flow, the area increases to about 7.07 mm². The required speed is about 21.2 mm/s, with a corresponding retraction distance of approximately 0.225 mm under 1000 mm/s² acceleration. Since the distance is less than available stroke which is 1 mm and the retraction speed is less than the maximum needle speed, a rapid retraction can be performed.

Case 3. A smaller 1.0 mm needle results in a reduced cross-section of about 0.785 mm². To offset 50 mm³/s flow, the needle must reach approximately 63.7 mm/s speed, which requires a retraction distance of about 0.405 mm under the same 5000 mm/s² acceleration. Since the calculated retraction speed is greater than the maximum permissible needle speed which is 50 mm/s, a rapid retraction is not feasible under the given conditions, and alternative pressure relief or flow control strategies may be appropriate.

Case 4. Using a 2.0 mm needle at a high flow rate of 500 mm³/s and only 1000 mm/s² acceleration, the required speed is about 159.2 mm/s. Although the required retraction speed is within the allowable needle speed limit (159.2 mm/s<200 mm/s), the distance required to reach that speed (approximately 12.7 mm) exceeds the available stroke (1 mm). Therefore, a rapid retraction is not feasible under the given conditions, and alternative pressure relief or flow control strategies may be appropriate.

In certain embodiments, the actual valve retraction speed and travel distance may exceed the calculated values to ensure reliable operation under real-world conditions. A person skilled in the art will appreciate that such adjustments may be appropriate to compensate for the time required for the printhead to separate from the deposited material, as well as to account for variations in material properties, mechanical compliance, actuator response times, or other process-specific factors. For example, the valve retraction speed or travel distance may be increased by an amount of 5%, 10%, 15%, 20%, 25%, 50%, 100%, 200%, 500%, or even 1000% or more relative to the calculated values. These modifications may be empirically determined or derived from system-specific calibration procedures, and are considered to fall within the scope of the present disclosure. Conversely, in embodiments where precision or flow interruption fidelity is less critical—such as in low-speed printing, non-foaming materials, or geometries tolerant to stringing—the valve retraction parameters may be reduced below the calculated values.

### Example 2 (Deposition of a Segment Insufficient for Valve Closure with Open Valve and Rapid Retraction)

FIG. 7A illustrates exemplary graphs of deposition speed, feed rate, and valve position during the deposition of a segment that is deemed to be insufficient for full valve closure (e.g., as determined in step 2020 of flowchart 2000), or where valve closure is not required (e.g., as determined in step 2060 of flowchart 2000). The deposition is concluded with a rapid valve retraction. The initiation of the rapid valve retraction is indicated by point 7080 on each graph. As shown in the speed profile graph 7420, in order to compensate for the transient flow offset associated with acceleration of the valve element to a required speed (such as calculated in Example 1), and to maintain deposition rate consistency, the system performs a sharp deceleration of the deposition speed after point 7080, shortly prior to the end of the segment.

This strategy enables interruption of material flow at the segment's end and promotes a clean separation between the deposited segment and the printhead, thereby improving print quality and minimizing oozing or stringing artifacts.

### Example 3 (Deposition of Segment Sufficient for Valve Closure)

FIG. 7B shows graphs of deposition speed, feed rate, and valve position during deposition of a segment in a scenario in which valve closure is required and the segment is deemed sufficient to permit such closure (e.g., as determined in step 2020 of flowchart 2000) and valve closure is called for (e.g., as determined in step 2060 of flowchart 2000). The printhead initiates extrusion prior to the start of deposition at a feed rate greater than the nominal feed rate, as shown in the feed rate profile graph 7210, and accelerates during the initial portion of the segment, as shown in the speed profile graph 7220, in order to compensate for pressure lag and maintain a deposition rate consistent with intended printed geometry.

### Example 4 (Deposition of Segment Insufficient for Valve Closure with Rapid Retraction)

FIG. 7C shows graphs of deposition speed, feed rate, and valve position during deposition of a segment in a scenario where valve closure is required but the segment is deemed to be insufficient to allow such closure (e.g., as determined in step 2020 of flowchart 2000).

The printhead interrupts extrusion substantially concurrently with initiation of valve closure at point 7060. The material displaced from the nozzle by the movable element of the valve during its closure compensates for the pressure drop within the polymer processing space resulting from extrusion interruption. This compensation maintains a deposition rate consistent with the desired printed geometry. Because the segment is deemed insufficient to complete a normal valve closure, the system initiates an escape move (e.g., as in step 2070 of flowchart 2000). Prior to initiating the escape move, the printhead performs a rapid valve retraction (e.g., step 2050 of flowchart 2000), which begins at point 7080, shortly prior to the escape move.

Such processes with partial valve closure may also be employed in scenarios where valve closure is not called for. For example, a partial valve closure may be executed to prepare the valve for a rapid retraction (such as through the sequence of steps 2040, 2050, 2060, and 2080 of flowchart 2000) by positioning the movable element of the valve closer to its seat. This positioning facilitates additional available stroke during retraction and results in a more responsive and controlled interruption of material flow.

### Example 5 (Deposition of Segment Insufficient for Valve Closure with Rapid Retraction Adapted to In-Situ Foaming or Reactive Materials)

FIG. 7D shows graphs of deposition speed, feed rate, and valve position during deposition of a segment in a scenario where valve closure is called for, but the segment is deemed insufficient for such valve closure (e.g., as determined in step 2020 of flowchart 2000). The process illustrated in FIG. 7D is particularly well-suited for use with reactive materials or materials that undergo foaming within the polymer processing space. A common challenge associated with such materials in the buildup of internal pressure upon valve closure, which can result in undesirably high discharge rate upon initiation of valve opening—exceeding a flow rate required to maintain established deposition rate for the initial portion of the segment. To mitigate this issue, the process shown in FIG. 7D employs progressive valve opening during deposition of the initial portion of the segment. After the system reaches nominal deposition speed at point 7050, the feed rate is interrupted (point 7070), a partial valve closure is initiated (point 7060), and a rapid valve retraction is initiated (7080), thereby enabling consistent segment initiation and clean segment termination under challenging material conditions.

### Example 6 (Deposition of Segment Insufficient for Valve Closure, Adapted for Thermally Sensitive Materials)

FIG. 7E shows graphs of deposition speed, feed rate, and valve position during deposition of a segment in a scenario where the valve closure is required, but the segment is deemed insufficient for such valve closure (e.g., as determined in step 2020 of flowchart 2000). The process illustrated in FIG. 7D is adapted for thermally sensitive materials, where minimizing extrusion downtime is critical to maintaining thermal consistency. As shown, the feed rate is preserved at or near the nominal value after initiation of valve closure (point 7070), as depicted in the feed rate profile graph 7510. Concurrently, depo speed is increased after point 7060 to compensate for the additional volumetric flow resulting from material displacement caused by motion of valve's movable element during closure, as shown in the speed profile graph 7520.

### EXAMPLE SOLUTIONS

Some embodiments may implement one or more of the following solutions, listed in clause-format. The following clauses are supported and further described in the embodiments above and throughout this document.

Solution 1. A manufacturing system comprising: a printhead comprising a nozzle, a pressure-generating mechanism configured to advance a polymer material through a polymer processing space toward the nozzle, and an actively controlled valve comprising a valve element and configured to regulate discharge of the polymer material from the nozzle; a motion system configured to move the printhead relative to a build surface along a toolpath comprising a plurality of deposition segments separated by one or more non-printing moves; a purging station configured to receive or remove excess polymer material from the printhead, the purging station comprising at least one of (i) a receiver configured to collect excess polymer material discharged from the nozzle or (ii) a wiping unit configured to remove residual polymer material from the nozzle; and a control system operably coupled to the printhead, the actively controlled valve, the pressure-generating mechanism, and the motion system, the control system being configured to execute machine-control instructions that, for a transition from a current deposition segment to a subsequent deposition segment of the toolpath, cause the control system to select and execute one of a plurality of transition protocols based at least in part on whether a terminal portion of the current deposition segment is sufficient to accommodate an expected excess discharge volume associated with transitioning the actively controlled valve toward a closed state, the expected excess discharge volume comprising at least one of (i) material displaced by the valve element during valve closure or (ii) material discharged due to residual pressure in the polymer processing space, wherein the plurality of transition protocols comprises: a first transition protocol, selected when the terminal portion is sufficient to accommodate the expected excess discharge volume, in which the printhead deposits material along the terminal portion of the current deposition segment while the actively controlled valve transitions toward the closed state before the printhead performs a non-printing move toward the subsequent deposition segment; and a second transition protocol, selected when the terminal portion is not sufficient to accommodate the expected excess discharge volume, in which (i) the printhead and the purging station are brought into operative proximity by a non-printing move of at least one of the printhead or the purging station, (ii) the purging station receives or removes excess polymer material from the printhead, and (iii) the printhead thereafter performs a non-printing move toward the subsequent deposition segment. In some embodiments, the valve element is a movable valve element.

Solution 2. The system of any one or more solutions disclosed herein, wherein the machine-control instructions comprise at least one of G-code, motion-control commands, valve-position commands, pressure-generating-mechanism commands, feed-rate commands, or purge commands.

Solution 3. The system of any one or more solutions disclosed herein, wherein the machine-control instructions are received from a computing device external to the manufacturing system, the machine-control instructions encoding the selection of the transition protocol such that the control system is configured to execute the selected transition protocol without performing the selection during the transition.

Solution 4. The system of any one or more solutions disclosed herein, wherein the machine-control instructions are generated before fabrication of an object by a slicer, computer-aided manufacturing system, cloud-based processing system, or other computing system separate from the manufacturing system.

Solution 5. The system of any one or more solutions disclosed herein, wherein the expected excess discharge volume comprises at least one of (i) material discharged due to continued operation of the pressure generator during valve closure, (ii) material discharged due to a pressure buildup within the polymer processing space associated with in-situ foaming of the polymer material, or (iii) material displaced from the polymer processing space by thermal expansion of the polymer material.

Solution 6. The system of any one or more solutions disclosed herein, wherein the terminal portion is deemed sufficient to accommodate the expected excess discharge volume when an intended deposition volume of the terminal portion is sufficient to receive at least a portion of the expected excess discharge volume without exceeding a permitted over-deposition threshold.

Solution 7. The system of any one or more solutions disclosed herein, wherein, during the first transition protocol, the control system is configured to cause operation of the pressure generating mechanism to be reduced or paused concurrently with initiation of transition of the actively controlled valve toward the closed state.

Solution 8. The system of any one or more solutions disclosed herein, wherein, during the first transition protocol, the control system is configured to cause the pressure-generating mechanism to continue operating during at least part of the transition of the actively controlled valve toward the closed state and to maintain a pressure within the polymer processing space sufficient to discharge polymer material from the nozzle throughout said part.

Solution 9. The system of any one or more solutions disclosed herein, wherein, during the first transition protocol, the control system is configured to cause a deposition speed of the printhead along the terminal portion to be modified during transition of the actively controlled valve toward the closed state, the modification comprising at least one of (i) deceleration of the deposition speed toward an endpoint of the terminal portion or (ii) acceleration of the deposition speed during a portion of the valve closure to compensate for material displaced by the valve element.

Solution 10. The system of any one or more solutions disclosed herein, wherein the actively controlled valve comprises an actuator operably coupled to the valve element and configured to retract the valve element from at least a portion (e.g., a downstream portion) of the polymer processing space, and wherein at least one of the plurality of transition protocols comprises a rapid valve retraction in which the actuator retracts the valve element at a rate sufficient to create a volumetric expansion in the at least a portion that temporarily reduces or interrupts discharge of the polymer material from the nozzle.

Solution 11. The system of any one or more solutions disclosed herein, wherein a volumetric expansion rate produced by the rapid valve retraction substantially offsets a volumetric discharge rate of the polymer material from the nozzle immediately preceding the rapid valve retraction.

Solution 12. The system of any one or more solutions disclosed herein, wherein the non-printing movement bringing the printhead and the purging station into operative proximity comprises increasing a distance between the nozzle and material deposited along the current deposition segment by at least one of (i) raising the printhead, (ii) lowering the build surface, or (iii) moving the build surface laterally relative to the printhead, before or during the non-printing move.

Solution 13. The system of any one or more solutions disclosed herein, wherein the purging station comprises the receiver, the receiver being fluidly coupled to a waste collection tank through a conduit, and wherein the waste collection tank is operably coupled to a vacuum source configured to draw material discharged from the printhead into the waste collection tank.

Solution 14. The system of any one or more solutions disclosed herein, wherein the receiver or the printhead is movable to establish substantial proximity between an entry port of the receiver and the nozzle during removal of discharged material.

Solution 15. The system of any one or more solutions disclosed herein, wherein the vacuum source comprises a centralized vacuum source fluidly coupled to the receiver of the purging station and to one or more additional receivers of one or more additional manufacturing systems, or wherein the waste collection tank comprises a central waste reservoir fluidly coupled to the receiver of the purging station and to one or more additional receivers of one or more additional manufacturing systems.

Solution 16. The system of any one or more solutions disclosed herein, wherein the purging station comprises the wiping unit, the wiping unit being mounted to contact the nozzle of the printhead to remove residual polymer material adhering to the nozzle and comprising at least one of a blade, a wire, a brush, or a high-speed actuator carrying a wiping element.

Solution 17. The system of any one or more solutions disclosed herein, wherein, during the first transition protocol, the control system is configured to cause a rate of transition of the actively controlled valve toward the closed state to increase toward an endpoint of the terminal portion to compensate for a declining residual pressure within the polymer processing space.

Solution 18. The system of any one or more solutions disclosed herein, wherein, in connection with a transition into the subsequent deposition segment, the control system is configured to cause the actively controlled valve to transition from the closed state toward a nominal state progressively along an initial portion of the subsequent deposition segment, such that polymer material displaced from the polymer processing space by the valve element during opening is deposited within the initial portion.

Solution 19. The system of any one or more solutions disclosed herein, wherein the polymer material is a foaming polymer formulation and the control system is configured to cause the actively controlled valve to open progressively along the initial portion to mitigate over-extrusion at the beginning of the subsequent deposition segment caused by pressure buildup associated with in-situ foaming.

Solution 20. The system of any one or more solutions disclosed herein, wherein the transition of the actively controlled valve from the closed state toward the nominal state extends across two or more deposition segments of the toolpath, the control system causing progressive opening of the actively controlled valve along the two or more deposition segments.

Solution 21. The system of any one or more solutions disclosed herein, wherein the control system is configured to direct the printhead into operative proximity with the purging station independently of the plurality of transition protocols when at least one of the following conditions is met: (i) a continuous extrusion threshold is exceeded; (ii) a valve actuation count within a specified time interval is exceeded; or (iii) a minimum extrusion threshold for a layer of the toolpath has not been met during fabrication of the layer.

Solution 22. The system of any one or more solutions disclosed herein, wherein, during the second transition protocol, the printhead executes a wiping movement at an endpoint of the terminal portion of the current deposition segment before the printhead and the purging station are brought into operative proximity, the wiping movement facilitating separation of polymer material deposited along the current deposition segment from polymer material within the nozzle.

Solution 23. The system of any one or more solutions disclosed herein, comprising at least one of: a subtractive manufacturing tool operably coupled to the motion system and configured to perform a subtractive operation on polymer material previously deposited by the printhead, or an insulated chamber configured to contain debris generated by the subtractive operation.

Solution 24. The system of any one or more solutions disclosed herein, wherein the motion system comprises one of a Cartesian positioning system, a delta positioning system, a robotic-arm positioning system, a belt-type infinite-build positioning system, and a multi-axis positioning system having at least five degrees of freedom.

Solution 25. The system of any one or more solutions disclosed herein, wherein in the second transition protocol the printhead is configured to perform the non-printing move toward the subsequent deposition segment with the actively controlled valve in the closed state.

Solution 26. The system of any one or more solutions disclosed herein, wherein: the plurality of transition protocols comprises a third transition protocol, selected when the terminal portion is not sufficient to accommodate the expected excess discharge volume and a non-printing move toward the subsequent deposition segment satisfies an open-valve-travel condition, in which the printhead performs the non-printing move toward the subsequent deposition segment with the actively controlled valve in an open or partially open state, and the open-valve-travel condition is satisfied when at least one of the following is below a respective predetermined or dynamically evaluated threshold: an expected volume of polymer material that would be discharged from the nozzle during the non-printing move with the actively controlled valve in the open or partially open state; a length of the non-printing move toward the subsequent deposition segment; or a duration of the non-printing move toward the subsequent deposition segment.

Solution 27. A manufacturing system, comprising: a printhead comprising a nozzle, a pressure generator, and an actively controlled valve comprising a valve element configured to regulate discharge of polymer material from the nozzle; a motion system configured to move the printhead relative to a build surface along a toolpath comprising a plurality of deposition segments separated by non-printing moves; and a control system operably coupled to the printhead, the actively controlled valve, the pressure generator, and the motion system, the control system being configured to execute machine-control instructions that, for a transition from a current deposition segment of the toolpath to a subsequent deposition segment of the toolpath: evaluate whether a terminal portion of the current deposition segment is sufficient to accommodate an expected excess discharge volume associated with transitioning the actively controlled valve toward a closed state, and when the terminal portion is not sufficient, cause the printhead to (i) perform a non-printing move from the current deposition segment to a purge structure deposited within a workspace of the manufacturing system, (ii) deposit at least a portion of the expected excess discharge volume onto the purge structure with the actively controlled valve in at least a partially open state, and (iii) subsequently move toward the subsequent deposition segment.

Solution 28. A manufacturing system, comprising: a printhead comprising a nozzle, a pressure generator configured to advance a polymer material through a polymer processing space toward the nozzle, and an actively controlled valve comprising a valve element configured to be introduced into and retracted from at least a portion (e.g., a downstream portion) of the polymer processing space to regulate discharge of the polymer material from the nozzle; an actuator operably coupled to the valve element and configured to retract the valve element from the at least a portion of the polymer processing space at a controlled acceleration and a controlled stroke; a motion system configured to move the printhead relative to a build surface along a toolpath comprising a plurality of deposition segments separated by non-printing moves; and a control system operably coupled to the printhead, the actively controlled valve, the actuator, the pressure generator, and the motion system, the control system being configured to cause, during or immediately receding completion of a current deposition segment of the toolpath, a rapid valve retraction in which the actuator retracts the valve element from the at least a portion of the polymer processing space at a rate sufficient to create a volumetric expansion in the at least a portion that temporarily reduces or interrupts discharge of the polymer material from the nozzle and facilitates separation of polymer material deposited along the current deposition segment from polymer material within the nozzle, followed by a non-printing move of the printhead away from the current deposition segment. In some embodiments, the valve element is a movable valve element.

Solution 29. The system of any one or more solutions disclosed herein, wherein the actuator comprises at least one of a voice coil actuator, a piezoelectric actuator, a linear motor, a stepper motor, or a high-speed servo actuator.

Solution 30. A method of fabricating an object using a manufacturing system, the manufacturing system comprising a printhead comprising a nozzle, a pressure generator configured to advance a polymer material through a polymer processing space toward the nozzle, and an actively controlled valve comprising a valve element and configured to regulate discharge of the polymer material from the nozzle, a motion system configured to move the printhead relative to a build surface along a toolpath; a purging station configured to receive or remove excess polymer material from the printhead; and a control system, the method comprising: receiving or executing machine-control instructions defining the toolpath, the toolpath comprising a current deposition segment, a subsequent deposition segment, and a transition therebetween; depositing the polymer material from the printhead along the current deposition segment; executing, for the transition, a selected transition protocol selected from a plurality of transition protocols based at least in part on whether a terminal portion of the current deposition segment is sufficient to accommodate an expected excess discharge volume associated with transitioning the actively controlled valve toward a closed state, the expected excess discharge volume comprising at least one of (i) material displaced by the valve element during valve closure or (ii) material discharged due to residual pressure in the polymer processing space, wherein the plurality of transition protocols comprise: a first transition protocol, selected when the terminal portion is sufficient to accommodate the expected excess discharge volume, comprising depositing the polymer material along the terminal portion of the current deposition segment while the actively controlled valve transitions toward the closed state, before performing a non-printing move of the printhead toward the subsequent deposition segment; and a second transition protocol, selected when the terminal portion is not sufficient to accommodate the expected excess discharge volume, comprising (i) bringing the printhead and the purging station into operative proximity by a non-printing move of at least one of the printhead or the purging station, (ii) receiving or removing excess polymer material from the printhead at the purging station, and (iii) thereafter performing a non-printing move of the printhead toward the subsequent deposition segment.

Solution 31. The method of any one or more solutions disclosed herein, comprising performing a rapid valve retraction during or immediately preceding completion of the current deposition segment by retracting the valve element from at least a portion (e.g., a downstream portion) of the polymer processing space at a rate sufficient to create a volumetric expansion in the at least a portion that temporarily reduces or interrupts discharge of the polymer material from the nozzle.

Solution 32. The method of any one or more solutions disclosed herein, wherein bringing the printhead and the purging station into operative proximity comprises increasing a distance between a nozzle of the printhead and material deposited along the current deposition segment by at least one of (i) raising the printhead, (ii) lowering a build surface of the manufacturing system, or (iii) moving the build surface laterally relative to the printhead, before or during the non-printing movement.

Solution 33. A computer-implemented method for generating machine-control instructions that, when executed by a manufacturing system comprising a printhead and an actively controlled valve comprising a valve element, cause the manufacturing system to fabricate a three-dimensional object by advancing a polymer material through a polymer processing space toward a nozzle of the printhead and discharging the polymer material through the nozzle in a controlled manner regulated by the actively controlled valve, the computer-implemented method comprising: receiving toolpath data comprising a plurality of deposition segments and one or more non-printing moves between the deposition segments; for at least one transition from a current deposition segment to a subsequent deposition segment of the plurality of deposition segments, determining, based on at least one of a length of the current deposition segment, a volume of the current deposition segment, or a parameter of the actively controlled valve, whether a terminal portion of the current deposition segment is sufficient to accommodate an expected excess discharge volume associated with transitioning the actively controlled valve toward a closed state; when the terminal portion is sufficient, generating first machine-control instructions configured to cause the manufacturing system to deposit material along the terminal portion while transitioning the actively controlled valve toward the closed state before performing a non-printing move toward the subsequent deposition segment; and when the terminal portion is not sufficient, generating second machine-control instructions configured to cause the manufacturing system to direct the printhead to a purging station configured to receive or remove excess polymer material from the printhead, cause the purging station to receive or remove excess polymer material from the printhead, and thereafter direct the printhead in a non-printing move toward the subsequent deposition segment; and outputting the first or second machine-control instructions for execution by the manufacturing system.

Solution 34. The computer-implemented method of any one or more solutions disclosed herein, wherein the determining further comprises evaluating at least one of: a valve actuation speed of the actively controlled valve, a volumetric flow rate of the polymer material through the nozzle, a material type of the polymer material, a temperature of the polymer material within the polymer processing space, or a foaming or thermal-expansion characteristic of the polymer material.

Solution 35. A non-transitory computer-readable medium storing instructions that, when executed by one or more processors, cause the one or more processors to perform the computer-implemented method of any one or more solutions disclosed herein, the medium being readable by a controller of a manufacturing system or by a computing system configured to communicate the machine-control instructions to a manufacturing system.

Solution 36. A method of fabricating an object using a manufacturing system of any one or more solutions disclosed herein.

What is claimed is:

1. A manufacturing system comprising:
a printhead comprising a nozzle, a pressure-generating mechanism configured to advance a polymer material through a polymer processing space toward the nozzle, and an actively controlled valve comprising a valve element and configured to regulate discharge of the polymer material from the nozzle;
a motion system configured to move the printhead relative to a build surface along a toolpath comprising a plurality of deposition segments separated by one or more non-printing moves;
a purging station configured to receive or remove excess polymer material from the printhead, the purging station comprising at least one of (i) a receiver configured to collect excess polymer material discharged from the nozzle or (ii) a wiping unit configured to remove residual polymer material from the nozzle; and
a control system operably coupled to the printhead, the actively controlled valve, the pressure-generating mechanism, and the motion system, the control system being configured to execute machine-control instructions that, for a transition from a current deposition segment to a subsequent deposition segment of the toolpath, cause the control system to select and execute one of a plurality of transition protocols based at least in part on whether a terminal portion of the current deposition segment is sufficient to accommodate an expected excess discharge volume associated with transitioning the actively controlled valve toward a closed state, the expected excess discharge volume comprising at least one of (i) material displaced by the valve element during valve closure or (ii) material discharged due to residual pressure in the polymer processing space,
wherein the plurality of transition protocols comprises:
a first transition protocol, selected when the terminal portion is sufficient to accommodate the expected excess discharge volume, in which the printhead deposits material along the terminal portion of the current deposition segment while the actively controlled valve transitions toward the closed state before the printhead performs a non-printing move toward the subsequent deposition segment; and
a second transition protocol, selected when the terminal portion is not sufficient to accommodate the expected excess discharge volume, in which (i) the printhead and the purging station are brought into operative proximity by a non-printing move of at least one of the printhead or the purging station, (ii) the purging station receives or removes excess polymer material from the printhead, and (iii) the printhead thereafter performs a non-printing move toward the subsequent deposition segment.

2. The system of claim 1, wherein the machine-control instructions comprise at least one of G-code, motion-control commands, valve-position commands, pressure-generating-mechanism commands, feed-rate commands, or purge commands.

3. The system of claim 1, wherein the expected excess discharge volume comprises at least one of (i) material discharged due to continued operation of the pressure-generating mechanism during valve closure, (ii) material discharged due to a pressure buildup within the polymer processing space associated with in-situ foaming of the polymer material, or (iii) material displaced from the polymer processing space by thermal expansion of the polymer material.

4. The system of claim 1, wherein, during the first transition protocol, the control system is configured to cause at least one of the following:
operation of the pressure-generating mechanism to be reduced or paused concurrently with initiation of transition of the actively controlled valve toward the closed state;
the pressure-generating mechanism to continue operating during at least part of the transition of the actively controlled valve toward the closed state and to maintain a pressure within the polymer processing space sufficient to discharge polymer material from the nozzle throughout said part;
a deposition speed of the printhead along the terminal portion to be modified during transition of the actively controlled valve toward the closed state, the modification comprising at least one of (i) deceleration of the deposition speed toward an endpoint of the terminal portion or (ii) acceleration of the deposition speed during a portion of the valve closure to compensate for material displaced by the valve element; or
a rate of transition of the actively controlled valve toward the closed state to increase toward an endpoint of the terminal portion to compensate for a declining residual pressure within the polymer processing space.

5. The system of claim 1, wherein the actively controlled valve comprises an actuator operably coupled to the valve element and configured to retract the valve element from at least a portion of the polymer processing space, and wherein at least one of the plurality of transition protocols comprises a rapid valve retraction in which the actuator retracts the valve element at a rate sufficient to create a volumetric expansion in the at least a portion that temporarily reduces or interrupts discharge of the polymer material from the nozzle.

6. The system of claim 1, wherein the non-printing move bringing the printhead and the purging station into operative proximity comprises increasing a distance between the nozzle and material deposited along the current deposition segment by at least one of (i) raising the printhead, (ii) lowering the build surface, or (iii) moving the build surface laterally relative to the printhead, before or during the non-printing move.

7. The system of claim 1, wherein the purging station comprises the receiver, the receiver being fluidly coupled to a waste collection tank through a conduit, and wherein the waste collection tank is operably coupled to a vacuum source configured to draw material discharged from the printhead into the waste collection tank.

8. The system of claim 7, wherein the receiver or the printhead is movable to establish substantial proximity between an entry port of the receiver and the nozzle during removal of discharged material.

9. The system of claim 7, wherein the vacuum source comprises a centralized vacuum source fluidly coupled to the receiver of the purging station and to one or more additional receivers of one or more additional manufacturing systems, or wherein the waste collection tank comprises a central waste reservoir fluidly coupled to the receiver of the purging station and to one or more additional receivers of one or more additional manufacturing systems.

10. The system of claim 1, wherein the purging station comprises the wiping unit, the wiping unit being mounted to contact the nozzle of the printhead to remove residual polymer material adhering to the nozzle and comprising at least one of a blade, a wire, a brush, or a high-speed actuator carrying a wiping element.

11. The system of claim 1, wherein, in connection with a transition into the subsequent deposition segment, the control system is configured to cause the actively controlled valve to transition from the closed state toward a nominal state progressively along an initial portion of the subsequent deposition segment, such that polymer material displaced from the polymer processing space by the valve element during opening is deposited within the initial portion.

12. The system of claim 11, wherein the polymer material is a foaming polymer formulation and the control system is configured to cause the actively controlled valve to open progressively along the initial portion to mitigate over-extrusion at the beginning of the subsequent deposition segment caused by pressure buildup associated with in-situ foaming.

13. The system of claim 11, wherein the transition of the actively controlled valve from the closed state toward the nominal state extends across two or more deposition segments of the toolpath, the control system being configured to cause progressive opening of the actively controlled valve along the two or more deposition segments.

14. The system of claim 1, wherein, during the second transition protocol, the printhead executes a wiping movement at an endpoint of the terminal portion of the current deposition segment before the printhead and the purging station are brought into operative proximity, the wiping movement facilitating separation of polymer material deposited along the current deposition segment from polymer material within the nozzle.

15. The system of claim 1, comprising at least one of:
a subtractive manufacturing tool operably coupled to the motion system and configured to perform a subtractive operation on polymer material previously deposited by the printhead, or
an insulated chamber configured to contain debris generated by the subtractive operation.

16. The system of claim 1, wherein the motion system comprises one of a Cartesian positioning system, a delta positioning system, a robotic-arm positioning system, a belt-type infinite-build positioning system, and a multi-axis positioning system having at least five degrees of freedom.

17. The system of claim 1, wherein in the second transition protocol the printhead is configured to perform the non-printing move toward the subsequent deposition segment with the actively controlled valve in the closed state.

18. The system of claim 1, wherein:
the plurality of transition protocols comprises a third transition protocol, selected when the terminal portion is not sufficient to accommodate the expected excess discharge volume and a non-printing move toward the subsequent deposition segment satisfies an open-valve-travel condition, in which the printhead performs the non-printing move toward the subsequent deposition segment with the actively controlled valve in an open or partially open state, and
the open-valve-travel condition is satisfied when at least one of the following is below a respective predetermined or dynamically evaluated threshold:
an expected volume of polymer material that would be discharged from the nozzle during the non-printing move with the actively controlled valve in the open or partially open state;
a length of the non-printing move toward the subsequent deposition segment; or
a duration of the non-printing move toward the subsequent deposition segment.

19. A method of fabricating an object using a manufacturing system, the manufacturing system comprising a printhead comprising a nozzle, a pressure generator configured to advance a polymer material through a polymer processing space toward the nozzle, and an actively controlled valve comprising a valve element and configured to regulate discharge of the polymer material from the nozzle, a motion system configured to move the printhead relative to a build surface along a toolpath; a purging station configured to receive or remove excess polymer material from the printhead; and a control system, the method comprising:
receiving or executing machine-control instructions defining the toolpath, the toolpath comprising a current deposition segment, a subsequent deposition segment, and a transition therebetween;
depositing the polymer material from the printhead along the current deposition segment;
executing, for the transition, a selected transition protocol selected from a plurality of transition protocols based at least in part on whether a terminal portion of the current deposition segment is sufficient to accommodate an expected excess discharge volume associated with transitioning the actively controlled valve toward a closed state, the expected excess discharge volume comprising at least one of (i) material displaced by the valve element during valve closure or (ii) material discharged due to residual pressure in the polymer processing space,
wherein the plurality of transition protocols comprise:
a first transition protocol, selected when the terminal portion is sufficient to accommodate the expected excess discharge volume, comprising depositing the polymer material along the terminal portion of the current deposition segment while the actively controlled valve transitions toward the closed state, before performing a non-printing move of the printhead toward the subsequent deposition segment; and
a second transition protocol, selected when the terminal portion is not sufficient to accommodate the expected excess discharge volume, comprising (i) bringing the printhead and the purging station into operative proximity by a non-printing move of at least one of the printhead or the purging station, (ii) receiving or removing excess polymer material from the printhead at the purging station, and (iii) thereafter performing a non-printing move of the printhead toward the subsequent deposition segment.

20. A manufacturing system, comprising:
a printhead comprising a nozzle, a pressure generator configured to advance a polymer material through a polymer processing space toward the nozzle, and an actively controlled valve comprising a valve element configured to be introduced into and retracted from at least a portion of the polymer processing space to regulate discharge of the polymer material from the nozzle;
an actuator operably coupled to the valve element and configured to retract the valve element from the at least a portion of the polymer processing space at a controlled acceleration and a controlled stroke;
a motion system configured to move the printhead relative to a build surface along a toolpath comprising a plurality of deposition segments separated by non-printing moves; and
a control system operably coupled to the printhead, the actively controlled valve, the actuator, the pressure generator, and the motion system, the control system being configured to cause, during or immediately preceding completion of a current deposition segment of the toolpath, a rapid valve retraction in which the actuator retracts the valve element from the at least a portion of the polymer processing space at a rate sufficient to create a volumetric expansion in the at least a portion that temporarily reduces or interrupts discharge of the polymer material from the nozzle and facilitates separation of polymer material deposited along the current deposition segment from polymer material within the nozzle, followed by a non-printing move of the printhead away from the current deposition segment.
